(19) United States
(12) Patent Application Publication
(10) Pub. No.: US 2006/0134593 A1
(43) Pub. Date: Jun. 22, 2006

(54) Web deployed e-learning knowledge management system

(75) Inventors: Kerry S. Kalous, Algonquin, IL (US); Alfred Heyman, Nashville, TN (US)

Correspondence Address: LEVENFELD PEARLSTEIN;Intellectual Property Department, 2 North LaSalle, Suite 1300, CHICAGO, IL, 60602, US

(73) Assignee: Resource Bridge Toolbox, LLC, Schaumburg, IL (US)

(21) Appl. No.: 11/314,444

(22) Filed: Dec. 21, 2005

Related U.S. Application Data
(60) Provisional application No. 60/638,019, filed on Dec. 21, 2004.

(51) Int. Cl. G09B 3/00

(52) U.S. Cl. 434/350

(57) ABSTRACT

A web deployed e-learning knowledge management system for remote learning users and remote management controls is disclosed, comprising, in the preferred embodiment: (a) a login system for authenticating users and permitting access to the proper portal; (b) a learner portal for allowing remote learners to access e-learning content; (c) a builder portal for allowing course developers to create and deploy e-learning content; (d) a manager portal for managing learners, course developers and their access to the learner and builder portals, and for preparing relevant reports (such as learner progress reports); (e) a super-administrator portal for establishing and managing access to the system and for preparing administrative system-related reports; and, (f) a database for storing data used by the four preceding portals and the login system. The present invention provides a comprehensive system that enables remote learning over a computer network.

### CROSS REFERENCE TO RELATED APPLICATION

This application claims the benefit of U.S. provisional patent application Ser. No. 60/638,019, titled “Web Deployed Learning Management System,” filed on Dec. 21, 2004, the contents of which are incorporated herein by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX

Not applicable.

### BACKGROUND OF THE INVENTION

(A) Field of the Invention

The present invention relates generally to a learning management system (“LMS”). More specifically, the present invention relates to a web deployed e-learning knowledge management system for remote learning users and remote management controls that enables remote learning over a computer network, such as the Internet, and enables course developers to create and deploy courses to remote learners, to manage the remote learners' access to the courses, to track the remote learners' progress through the courses, to study and analyze remote learners' test results and to develop and evaluate learning curricula. It also enables universities, corporations, or other administrative entities to setup, administer and monitor course developers' and remote learners' access to the system.

(B) Description of the Prior Art

In today's global economy, knowledge is key, and the ability to create, manage, and convey knowledge to geographically remote locations is critically valuable. For example, in a society where the Internet spreads knowledge instantaneously around the world through various networks reaching billions of people, those who best create, manage, and control the dissemination, content, and integration of knowledge and information will realize the greatest benefits from their efforts.

Knowledge is acquired through study, investigation, observation, and experience. It is conveyed through teaching, mentoring, and acting. The field of knowledge management deals with the collection, categorization, and storage of knowledge and information—the focus is on archiving and managing vast amounts of information, usually without any structured means for conveying the information to others, for example, the archiving of thousands of documents or recordation of certain experiences. Others may study, investigate, search, or retrieve the collected material, but this is in isolation and is not a part of a structured training program where it is used as a relevant case study.

Over the past decade, as the Internet has become an increasing part of our professional and personal lives, systems have been developed to use the functionality provided by the Internet to distribute knowledge. In one such example, online education has become an efficient, economical, and popular form of learning, particular for individuals who are geographically distant from an educational provider, such as a university or a corporate employer. Online education also benefits those who require a self-paced learning environment or those with physical disabilities who are unable to travel to remote locations for training and education.

One form of online education that has thrived over the past several years is known as “e-learning,” a form of distance learning in which traditional correspondence (mail-based) courses have been replaced by Internet courses. As used herein, the term “e-learning” is intended to encompass the concept of making educational and training materials and courses available to remote users, such as by using the Internet, or other public or private computer network. Numerous educational institutions, such as colleges and universities, as well as corporations seeking to train remotely located employees, have embraced e-learning as a valuable educational tool.

Not only does e-learning offer advantages to learners, it offers significant advantages to educational providers, such as universities and corporations. For example, e-learning courses are available to learners at any time, in any location. Thus, the cost to deliver e-learning courses is substantially less than traditional classroom education because no physical classroom structures are required. Moreover, e-learning permits instructors to create courses once and to reuse the courses repeatedly as needed, thereby reducing course development costs. Further, since the courses are electronic, rather than paper-based, there is a significant reduction in the cost of materials. Additionally, businesses that utilize e-learning for training employees save time and money by eliminating the travel and disruption of employee travel to training facilities.

The heart of a successful e-learning program is the process of creating and disseminating information in a controlled, structured and well-managed manner. This need has led to the creation of so-called “learning management systems” (“LMS's”). An LMS provides the platform for an e-learning environment by enabling the management, delivery and tracking of e-learning content. Several LMS's exist in the prior art; in fact, an entire suite of technical standards have been developed to enable various web-based LMS's to find, import, share, reuse and export learning content in a standardized way (the “Sharable Courseware Object Reference Model,” or SCORM). However, to the best of applicant's knowledge, no prior art LMS has integrated all of the novel aspects contained in the present invention.

Prior to the web deployed e-learning knowledge management system of the present invention, e-learning often was compact disc-based. Educational and training content was created and burned onto CD's. CD's were distributed to learners with instructions to complete the courses on the CD and report back with their results. However, the manual gathering and tracking of results created problems since not all learners were willing to submit their results. Another disadvantage was that any changes to course material meant significant time in reburning CD's, gathering old content and distributing new CD's. Often, it was difficult to gather old CD's and, in many instances, learners ended up with outdated course material. More problematic, users could not be tracked and training could not easily be limited to specific users or user groups.

Various prior art e-learning and LMS systems have been developed. However, to applicant's knowledge, none of prior art systems offer a complete and comprehensive LMS with the novel features of the present invention. For example, U.S. Pat. No. 6,944,624 discloses a method and system for creating and implementing personalized training programs and providing training services over an electronic network. However, the disclosed system focuses on an employee's retrieval of “canned” information from a database and does not contemplate a complete LMS as provided by the present invention.

U.S. Pat. No. 6,928,260 teaches an online education system and method in which an educator provider system is connected via the Internet to at least one student system so that at least one lesson can be transmitted from the provider system to the student system. However, the system disclosed in this patent is designed to ensuring that a student fully completes an educational or training lesson by forcing the student to listen to an audio file without the option to skip or fast forward through the audio. This system taught by this patent does not offer a comprehensive platform for creating, deploying and managing e-learning content.

Yet, another e-learning system is disclosed in U.S. Pat. No. 6,471,521. The invention taught by this patent is a system for implementing collaborative training and online learning over a computer network. The key element of this system is the ability for student users of the system to become a learning team, collaboratively working with other student users to complete educational tests and quizzes. Again, the system disclosed in this patent is directed to solving a specific problem, namely the ability for student users to collaborate during e-learning courses, rather than providing a comprehensive learning management system through which the entire e-learning process, from content creation and deployment, to tracking results, to administration, may be managed.

Therefore, what is needed is a web deployed e-learning knowledge management system that enables universities, colleges, corporations, and the like to create, deploy and manage easy-to-use, high quality e-learning courses to learners worldwide. The web deployed e-learning knowledge management system of the present invention satisfies that need. The system is designed for use by any university, corporation or other entity, any place in the world. The system is most useful for organizations with a distributed learning audience. The inventive learning management system solves a long-felt need by eliminating the requirement that trainers be sent to diverse locations. The system also solves the problem of deploying information in a timely manner and solves the problem of maintaining training content and results.

### SUMMARY OF THE INVENTION

The web deployed e-learning knowledge management system of the present invention consists, in the preferred embodiment, of six primary components: (a) a login system for authenticating users and permitting access to the proper portal; (b) a learner portal for allowing remote learners to access e-learning content; (c) a builder portal for allowing course developers to create and deploy e-learning content; (d) a manager portal for managing learners, course developers and their access to the learner and builder portals, and for preparing relevant reports (such as learner progress reports); (e) a super-administrator portal for establishing and managing access to the system and for preparing administrative system-related reports; and, (f) a database for storing data used by the four preceding portals and the login system.

In the preferred embodiment of the web deployed e-learning knowledge management system of the present invention, the four portals reside on a single web server computer, and the login system and database reside on a single database server computer. However, in other embodiments, the portals can be run from independent web servers, if desired, without affecting the functionality of the invention. The login system and each of the four portals are written in Microsoft ASP (“active server page”) code, and are designed to operate from Microsoft Internet Information Server, running on a Microsoft Windows 2000 Server (or newer) operating system. The database is created using Microsoft SQL Server 2000 software in the preferred embodiment. The web server computer and the database server computer communicate using traditional prior art networking hardware and software. The login system and portals use structured query language (“SQL”) to communicate with the database and to manage and view data from the database as needed.

The login system authenticates users of the system using standard authentication protocols that are well known in the prior art. Based on the type of user (learner, course developer, administrator, etc.), the login system allows the user to access the proper portal.

Learners are directed to the learner portal. A learner uses the learner portal to view courses available to the learner, register for courses, take courses, complete online assessments, and track personal history. The learner portal also provides access to supplemental course materials, such as course syllabi, schedules, required reading, and the like. It will be appreciated that the term “learner” as used throughout this disclosure refers to students, employees, or any other entity similarly situated that uses the system for education and/or training purposes.

Course developers (also referred to as “builders” throughout this disclosure) are directed to the builder portal, which allows course developers to create and deploy course content to learners. The builder portal also is used to create questions and tests for learners.

Corporate or university administrators are directed to the manager portal, which permits administrators to manage learners' and course developers' users access to the learner and builder portals, to create questions and tests for learners, and to prepare relevant reports.

Lastly, system administrators are directed to the super-administrator portal, which is used to manage universities, corporations and other customers of the system, and to run system-related administrative reports. For the purposes of this disclosure, and for ease of reference, customers of the system will described as “universities,” it being appreciated that the term “universities” includes universities, corporations or any other entity seeking to use the system to train or educate learners.

In the preferred embodiment, the database comprises a plurality of different database tables used to store various data related to the portals and the login systems. The database system and structure are well known in the prior art. The present invention comprises a normalized relational database wherein the database is programmed to store effectively different, but related, data for each of the four portals and for the login system, and has the ability to create scalable versions.

It therefore is a primary object of the web deployed e-learning knowledge management system of the present invention to provide a comprehensive system that enables remote learning over a computer network.

Another object of the present invention is to enable course developers to create and deploy courses to remote learners, to manage the remote learners' access to the courses, to track the remote learners' progress through the courses, to analyze remote learners' test results and to develop and evaluate learning curricula.

It is yet another object of the web deployed e-learning knowledge management system of the present invention to enable universities, corporations, or other administrative entities to setup, administer and monitor course developers' and remote learners' access to the system.

A further object of the present invention is to provide a flexible and scalable learning management system that can be used in connection with only a few learners to many hundreds of thousands of learners.

An additional object of the web deployed e-learning knowledge management system of the present invention is to provide a system that is platform- and software-independent for learners, requiring no special computer hardware or software downloads or plug-ins to use.

Yet, another object of the present invention is to provide a web deployed e-learning knowledge management system that is secured and limits access to portals only to authorized users.

Another object of the present invention is to provide course developers with a simple, intuitive way to quickly create and change course content.

A further objective of the web deployed e-learning knowledge management system is to provide a system that allows course developers to import into the system learning materials created in Microsoft PowerPoint or other presentation software that converts such materials into a format appropriate for use with the system.

An additional object of the present invention is to provide a system where course content may be reused for other courses and where changes to course content are automatically updated for all courses using such content.

A further object of the web deployed e-learning knowledge management system of the present invention is to provide a system that is compliant with the Sharable Courseware Object Reference Model (“SCORM”) to permit the import and export of data from other learning management systems.

Yet, another objective of the system of the present invention is to provide a system wherein a corporate or university administrator user of the system can assign various levels of administrative access to individuals or groups of users.

Another object of the web deployed e-learning knowledge management system of the present invention is to provide a system that generates online assessments (tests) based on a plurality of different question types and that automatically grades the assessments and provides learners with immediate feedback regarding the assessments including pass/fail notification.

A further object of the present invention is to provide a system wherein learners may be assigned to learner groups (such as based on geography, job title, or the like), and learners groups may be assigned multiple curricula.

An additional object of the present invention is to provide learners with a list of courses for which they are eligible to register and to permit learners to register for appropriate courses.

Yet, another object of the web deployed e-learning knowledge management system of the present invention is to provide a system in which learners can access course reference materials, such as articles, reports, photos, lists and other reference materials associated with a specific course.

Additional objects and advantages of the present invention will become apparent from the following description taken in conjunction with the accompanying drawings wherein are set forth, by way of illustration and example, certain embodiments of this invention. The drawings constitute a part of this specification, include exemplary embodiments of the present invention, and illustrate various objects and features thereof.

### BRIEF DESCRIPTION OF THE DRAWINGS

FIG. 1 is a block diagram showing the general operational relationship between the major components of the preferred embodiment of the learning management system of the present invention.

FIG. 2 is a flowchart showing the operation of the login portal in the preferred embodiment of the present invention

FIG. 3 is an exemplary interface for the login portal in the preferred embodiment of the present invention.

FIG. 4 is a series of flowcharts outlining the operation of the super-administrator portal in the preferred embodiment of the present invention.

FIG. 5 is a series of flowcharts outlining the operation of the manager portal in the preferred embodiment of the present invention.

FIG. 6 is a series of exemplary interfaces showing the navigation tree course drill down process in the preferred embodiment of the present invention.

FIG. 7 is a series of exemplary interfaces showing the management of curriculums in the preferred embodiment of the present invention.

FIG. 8 is a series of exemplary interfaces showing the management of courses in the preferred embodiment of the present invention.

FIG. 9 is a series of exemplary interfaces showing the management of questions and answers in the preferred embodiment of the present invention.

FIG. 10 is a series of exemplary interfaces showing the management of assessments in the preferred embodiment of the present invention.

FIG. 11 is a series of exemplary interfaces showing the management of learners in the preferred embodiment of the present invention.

FIG. 12 is a series of exemplary interfaces showing the management of builders in the preferred embodiment of the present invention.

FIG. 13 is a series of exemplary interfaces showing the management of reports in the preferred embodiment of the present invention.

FIG. 14 is a series of exemplary interfaces showing the management of university news in the preferred embodiment of the present invention.

FIG. 15 is a series of exemplary interfaces showing the management of university FAQ's in the preferred embodiment of the present invention.

FIG. 16 is a series of flowcharts outlining the operation of the builder portal in the preferred embodiment of the present invention.

FIG. 17 is a series of exemplary interfaces showing the management of various elements of the builder portal in the preferred embodiment of the present invention.

FIG. 18 is a flowchart outlining the operation of the PowerPoint conversion process in the preferred embodiment of the present invention.

FIG. 19 is an exemplary interface showing the builder report options in the preferred embodiment of the present invention

FIG. 20 is a series of flowcharts outlining the operation of the learner portal in the preferred embodiment of the present invention.

FIG. 21 is a series of exemplary interfaces showing the management of various elements of the learner portal in the preferred embodiment of the present invention.

FIG. 22 is a graphic representation of the related database tables associated with the course drilldown design in the preferred embodiment of the present invention.

FIG. 23 is a graphic representation of the related database tables associated with the learners and assignment of learners to groups in the preferred embodiment of the present invention.

FIG. 24 is a graphic representation of the related database tables associated with curriculum assignments to learners and groups in the preferred embodiment of the present invention.

FIG. 25 is a graphic representation of the related database tables associated with test and quiz question results in the preferred embodiment of the present invention.

FIG. 26 is a graphic representation of the related database tables associated with questions in the preferred embodiment of the present invention.

### DETAILED DESCRIPTION OF WEB DEPLOYED LEARNING MANAGEMENT SYSTEM

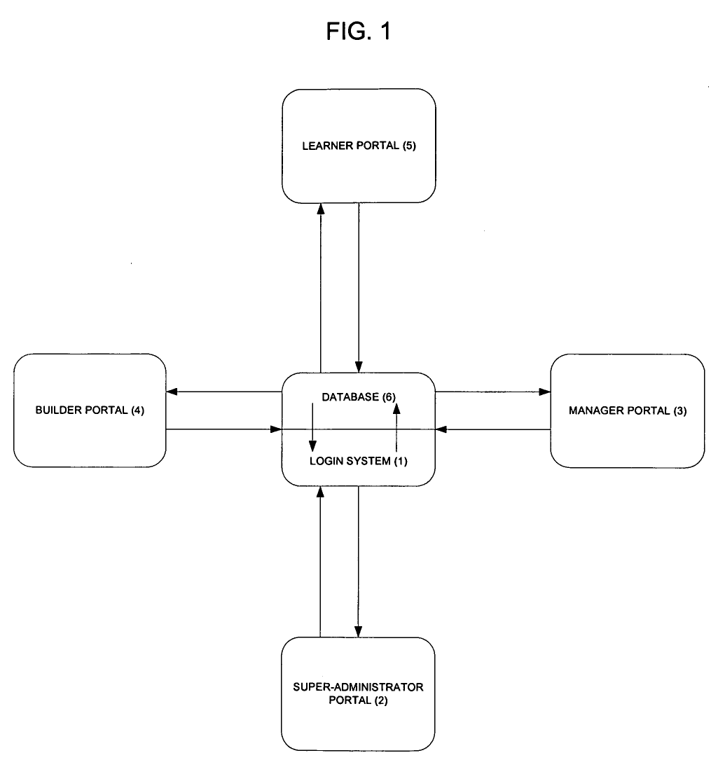

As shown in FIG. 1, the web deployed e-learning knowledge management system of the present invention consists of six primary components in the preferred embodiment: a login system 1 for authenticating users and permitting access to the proper portal; a super-administrator portal 2 for managing customer access to the system and for preparing administrative system-related reports; a builder portal 4 for allowing course developers to create and deploy e-learning content; a learner portal 5 for allowing remote learners to access e-learning content; a manager portal 3 for managing groups, courses, learners, course developers and university information, managing access to the learner and builder portals, and for preparing relevant reports (such as learner progress reports); and, a database 6 for storing data used by the four preceding portals and the login system. FIG. 1 shows the general operational relationship of the six primary components. A more detailed description of the design and operation of each component are presented below.

In the preferred embodiment of the web deployed e-learning knowledge management system of the present invention, the four portals and the login system reside (or are “hosted”) on a web server computer, and the database resides on a database server computer. The web server and database server computers are of the type that are well known to those skilled in the art, and generally consist of a processor, storage means, input and output means, and a means to network the computers with each other and with other computers for communications purposes. The web server and database server computers communicate using traditional networking hardware, software, and protocols. In the preferred embodiment, the login system and the four portals use Structured Query Language (“SQL”) to communicate with the database hosted on the database server and to retrieve and update data from the database as needed.

In the preferred embodiment, the login system and each of the four portals are written in Microsoft ASP (“active server page”) code, and are designed to operate from Microsoft Internet Information Server, running on a Microsoft Windows 2000 Server (or newer) operating system. This software platform is well known to those skilled in the art. Microsoft ASP code creates output in hypertext markup language (or “HTML”) code, which can be interpreted by, and viewed using, a traditional Internet web browsing program, such as Internet Explorer. It is important to note that other embodiments of the present invention could operate using other web server software, such as Sybase, Oracle, FileMaker, Apache Web Server, or 4D, as desired, without substantially affecting the operation of the system and without departing from the scope of this disclosure. The database in the preferred embodiment is created using Microsoft SQL Server 2000 software, again a platform well known to those skilled in the art. However, other suitable database software, such as Microsoft Access, Sybase, Oracle, FileMaker, and 4D, may be used without substantially affecting the operation of the system and without departing from the scope of this disclosure.

For ease of understanding, the operation of the web deployed e-learning knowledge management system of the present invention will be discussed in logical sequence beginning with the creation of high-level users of the system, such as universities and corporations, and continuing through to a learner's use of the system to complete an assigned course.

Login System

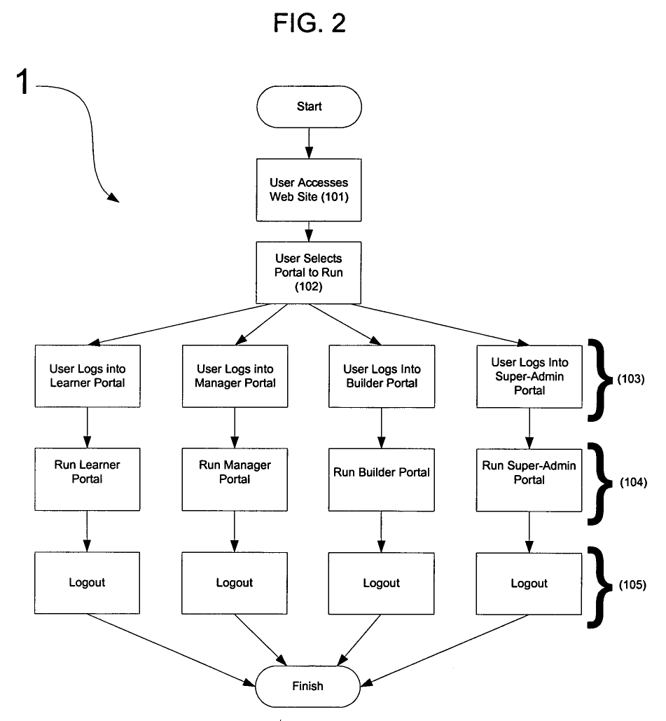

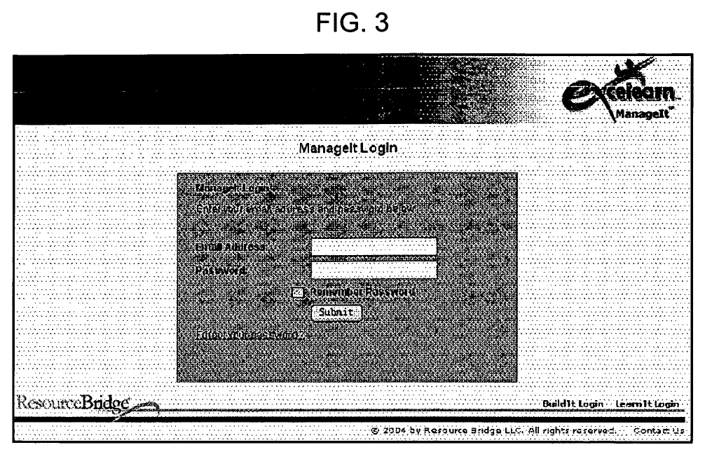

As shown in FIG. 2, login system 1 controls access to the web deployed e-learning knowledge management system of the present invention. A user desiring to enter the system navigates to the website for the system 101 using an Internet-connected computer system and web browser, such as a personal computer running the Windows XP operating system and the Internet Explorer web browser. Once on the system website, the user selects the desired portal 102 and is presented with a login screen to authenticate the user. In the preferred embodiment, authentication is accomplished by traditional prior art means known to those skilled in the art using a combination of a unique user identification along with a secure password. An exemplary login screen is shown in FIG. 3. Login system 1 receives the user's identification 301 and password 302 and communicates with database 6 using SQL to authenticate the user. If the user is authenticated as a proper user of the selected portal, the appropriate portal is activated and the user is permitted to access the portal 104. Login system 1 keeps the user logged in to the system until the user logs out of the portal 105. As a safety precaution, in some embodiments of the invention login system 1 may include a time-out feature that automatically logs out a user after a certain period of inactivity, such as fifteen minutes.

Super-Administrator Portal

Super-administrator portal 2 is designed to establish and manage university access to the web deployed e-learning knowledge management system of the present invention and to run system-related administrative reports. As used in this disclosure, a university is intended to refer to a university, corporation or other entity seeking to use the system to train or educate students, employees, and the like.

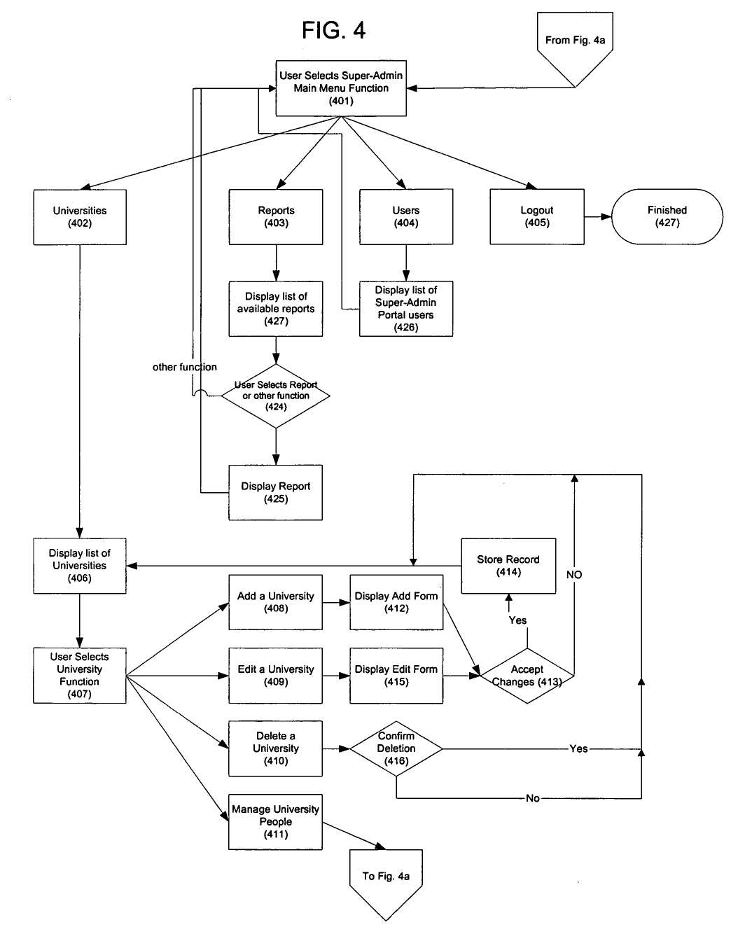

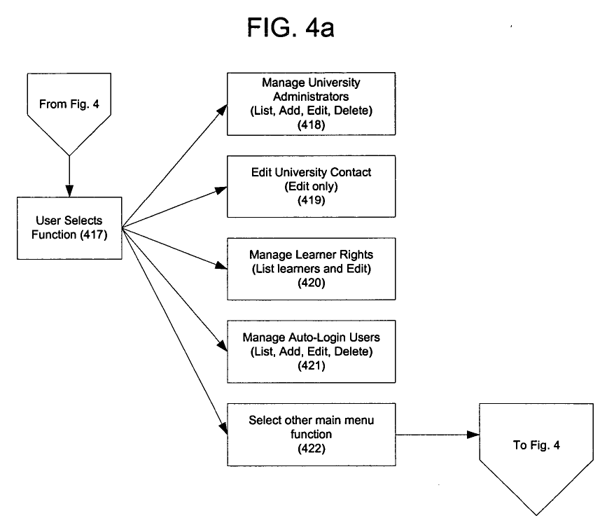

As shown in FIG. 4, once a super-administrator user accesses the super-administrator portal 2 using login system 1 as described above, the user is presented with a main menu of four super-administrator options 401: universities 402, reports 403, users 404, and logout 405.

The universities 402 option is used to add, edit, or delete universities and their contacts, such as university administrators, the university main contact person, learners, and auto-login users. Selecting the universities option 402 causes super-administrator portal 2 to communicate with database 6 using SQL to retrieve a list of universities registered on the system. Super-administrator portal 2 displays the list of registered universities 406 and offers the super-administrator user a menu of options 407 to: add a new university 408, edit information about an existing university 409, delete an existing university 410, or manage people associated with an existing university 411.

Choosing to add a new university 408 causes the super-administrator portal 2 to display a form 412 to the super-administrator user on which appear empty fields (such as university name, university address, etc.) that may be appropriated completed by the super-administrator user. Once the super-administrator user verifies and accepts the data 413, the super-administrator portal communicates the data to database 6 using SQL for storage 414. Additional universities may be added in a similar manner.

Similarly, choosing to edit information about a university 409 causes the super-administrator portal 2 to communicate with database 6, retrieve information about a university, and display the information on an editable form 415. Once the super-administrator user verifies and accepts the data 413, the super-administrator portal communicates the data to database 6 for storage 414.

The super-administrator also may choose to delete a university 410 displayed on the list of universities 6. Choosing to delete a university causes the super-administrator portal 2 to display a precautionary confirmation dialog requesting the super-administrator's confirmation that the university is to be deleted 416. Upon confirmation, super-administrator portal 2 communicates with database 6 to delete the record of the selected university.

As shown in FIGS. 4 and 4a, the super-administrator also may choose to manage people associated with a university 411. Choosing this option presents the super-administrator with five new options 417: managing (listing, adding, editing and/or deleting) university administrators 418, editing the university main contact person information 419, managing learner rights (listing and editing learners) 420, managing auto-login users (listing, adding, editing and/or deleting) 421. The super-administrator portal accomplishes the preceding functions by accepting data from the super-administrator and communicating with database 6 in a manner similar to adding a university 408, editing a university 409, and deleting a university 410 as previously described above. The super-administrator may also return 422 to the main menu of four super-administrator options 401 when management of university people is complete.

As further shown in FIG. 4, selecting the reports option 403 causes the super-administrator portal 2 to display a list of available reports 423 and prompt the super-administrator to select which report is to be viewed. Such reports generally are administrative in nature (such as a list of all universities, learners, course developers, etc.) and, in some embodiments of the present invention, may be custom programmed to obtain desired report output. The super-administrator then selects which report is to be created 424 and the super-administrator portal 2 communicates with database 6 to gather the required data and display the report 425. Once the report is displayed, the super-administrator is directed back to the main menu of four super-administrator options 401. In some embodiments of the web deployed e-learning knowledge management system of the present invention, the reports may be stored for future reference.

Additionally, as further shown in FIG. 4, the super-administrator may choose the users option 404. The users option 404 causes the super-administrator portal 2 to communicate with database 6 and gather and display a list of system users who are authorized to access the super-administrator portal 426. Lastly, as shown in FIGS. 2 and 4, the super-administrator may choose the logout option 405 which causes super-administrator portal 2 to close 427 and causes login system 1 to log the super-administrator out of the system 105.

Manager Portal

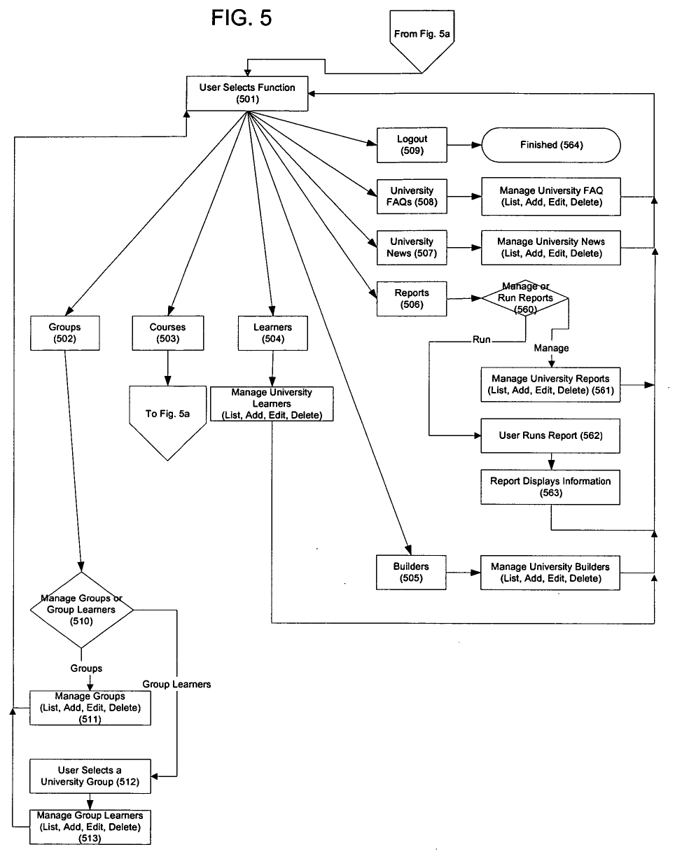

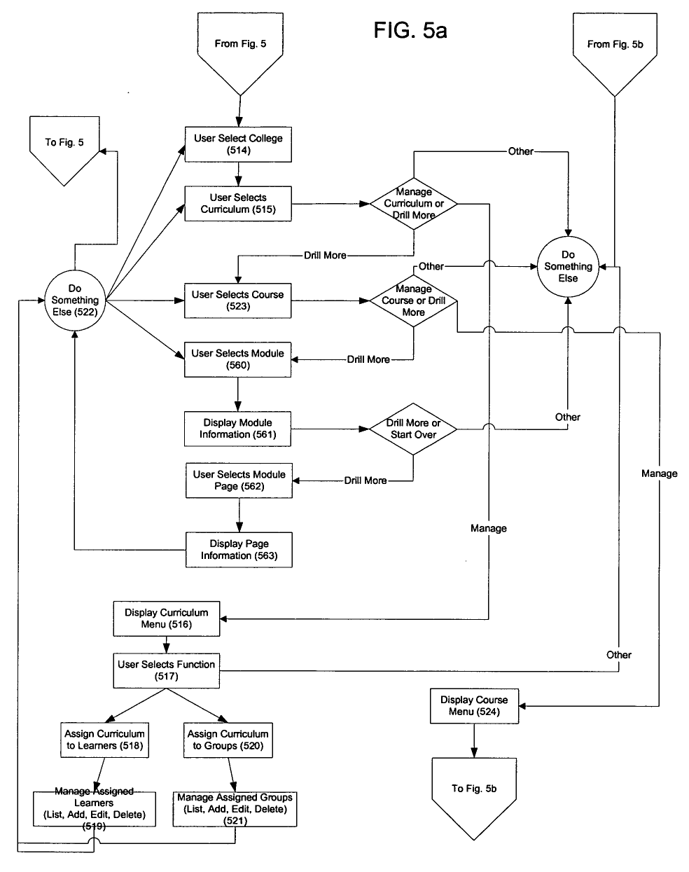

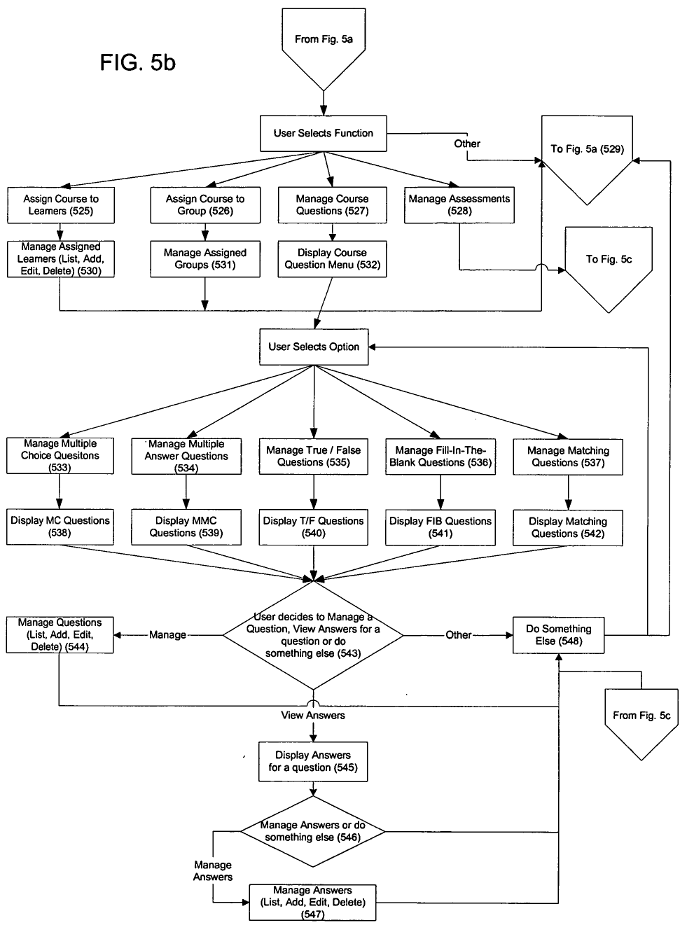

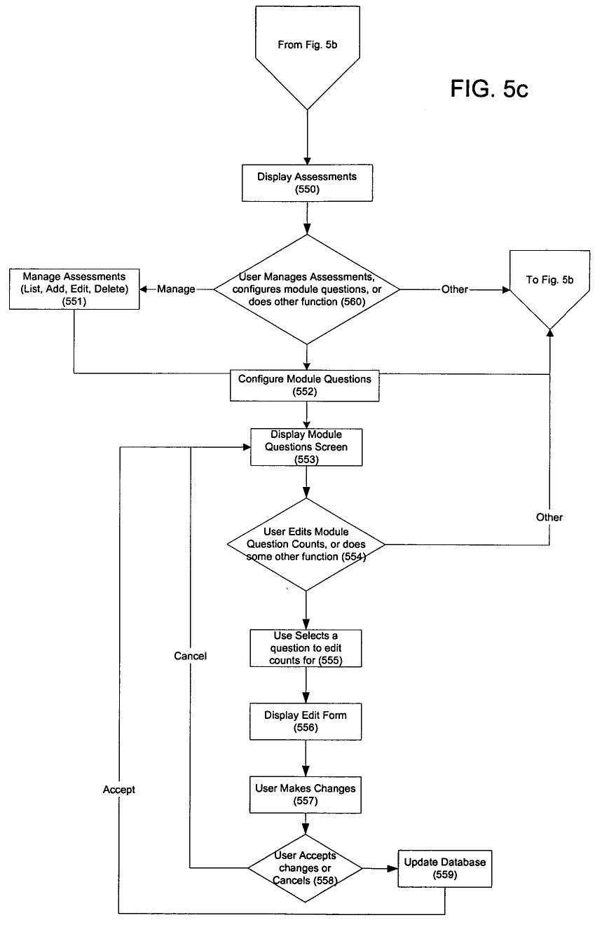

Manager portal 3 is designed to manage groups, courses, learners, builders and university information, to manage access to the learner and builder portals, and to prepare relevant reports. As shown in FIG. 5, once a university administrator accesses the manager portal 3 using login system 1 as described above, the university administrator is presented with a main menu of eight university administrator options 501: groups 502, courses 503, learners 504, builders 505, reports 506, news 507, frequently asked questions (“FAQ's”) 508, and logout 509.

Selecting the groups option 502 presents the university administrator with the option to manage groups or to group learners 510. Selecting manage groups 511 allows the university administrator to list, add, edit and/or delete groups (groups can include, for example, “All Students,” “Language Students,” “Visiting Students,” and the like). The manager portal accomplishes the preceding functions by accepting data from the university administrator and communicating with database 6 in a manner similar to adding a university 408, editing a university 409, and deleting a university 410 as previously described above.

Selecting the group learners option causes manager portal 3 to communicate with database 6 to obtain a list of groups which is displayed to the university manager. The university manager then selects a group 512 and the manager portal 3 displays a list of learners associated with that group (obtain via communication with database 6 as previously described) and presents the option to the university manger to add, edit, or delete learners from that group 513. The manager portal accomplishes the preceding functions by accepting data from the university administrator and communicating with database 6 in a manner similar to adding a university 408, editing a university 409, and deleting a university 410 as previously described above.

As further shown in FIG. 5, the university administrator may also choose the courses option 503. Courses option 503 is used to manage the creation and maintenance of courses for learners. The preferred embodiment of the present invention utilizes a hierarchical system to manage courses. In this system, universities are divided into colleges. Within each college are curriculums. Within each curriculum are courses. Within in each course are modules. Within each module are pages on which the substantive course materials appear. And, within each page are assets (graphics and the like) that appear on the page. The structure of this system will become more evident as further discussed below.

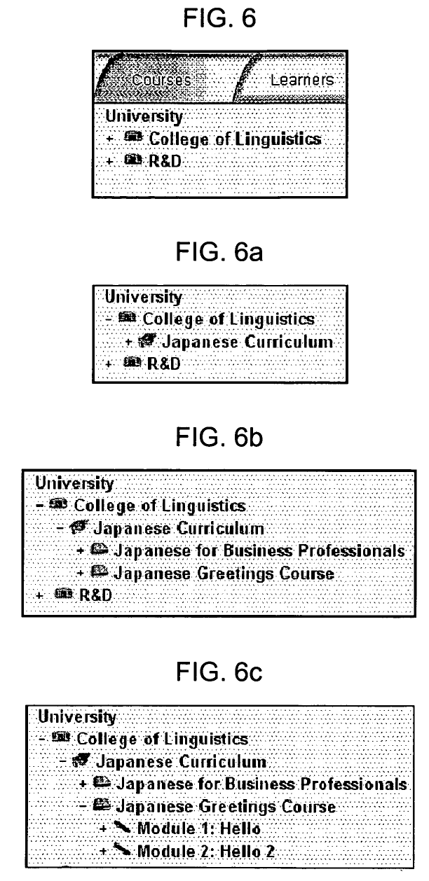

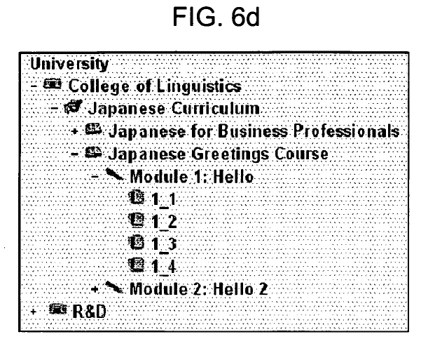

As shown in FIGS. 6-6d, in the preferred embodiment of the present invention, selection of colleges, curriculums, courses, curriculums, modules, and pages is accomplished through the use of a navigation tree, the structure of which is known in the prior art. As shown in FIG. 6, choosing courses option 503 reveals a list of colleges associated with the university administrator's university. As shown in FIG. 6a, clicking the “+” next to the name of a college (see 514 in FIG. 5a) expands the college to show curriculums associated with that college. As displayed in FIG. 6b, clicking the “+” next to the name of a curriculum (see 515 in FIG. 5a) expands the curriculum to show courses associated with that curriculum. Similarly, as displayed in FIG. 6c, clicking the “+” next to a course (see 523 in FIG. 5a) displays any modules associated with that course. As shown in FIG. 6d, clicking the “+” next to a module (see 560 in FIG. 5a) displays the pages that are associated with that module (see 561 in FIG. 5a). Selecting a particular page in a module 562 (FIG. 5a) displays information about that page 563 (FIG. 5a).

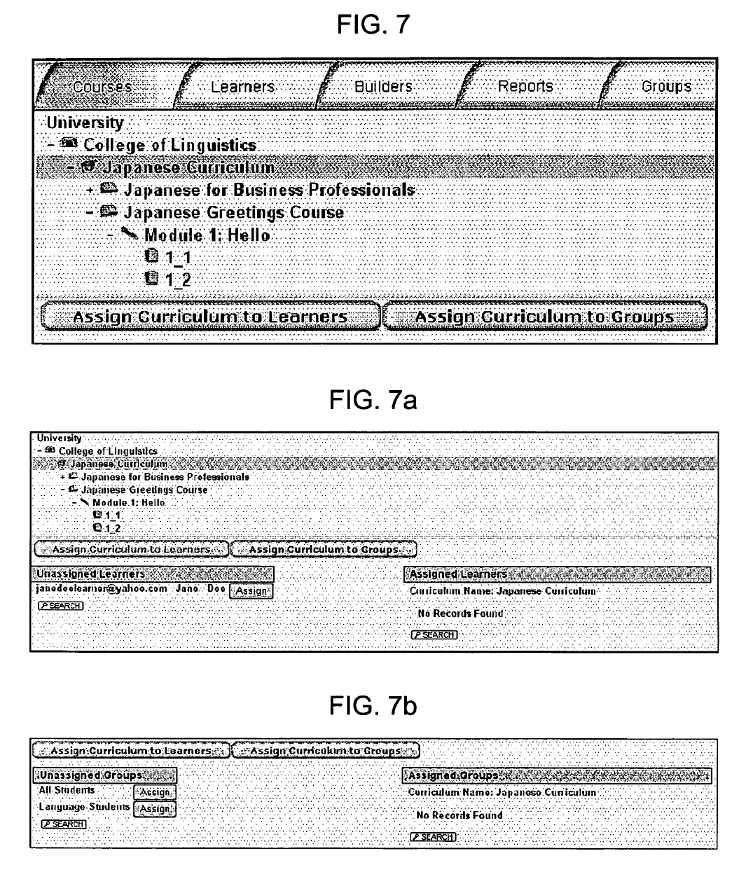

As shown in FIG. 5a, and with further reference to FIGS. 6-6d, choosing the courses option 503 presents the university administrator with a list of colleges associated with the university administrator's university as obtained from database 6. University administrator then selects the desired college 514. To manage a curriculum, the university administrator selects the desired curriculum 515 and the manager portal 3 displays options to assign the curriculum to learners or assign the curriculum to groups 516. University administrator then selects the desired function 517 (also shown in FIG. 7). Choosing the assign curriculum to learners option 518 provides the university administrator the ability to list, add, edit and/or delete learners assigned to the selected curriculum 519. Similarly, choosing the assign curriculum to groups option 520 provide the university administrator the ability to list, add, edit and/or delete groups of learners assigned to the selected curriculum 521. Listing, adding, editing and/or deleting learners and/or groups is accomplished in a manner similar to what has been described elsewhere in this disclosure, with manager portal 3 communicating with database 6 using SQL to retrieve, display, and modify the necessary information. The interfaces used to assign curriculums to learners and to assign curriculums to groups are shown in FIGS. 7a and 7b, respectively. As shown in FIG. 5a, when university administrator has completed curriculum assignments, he or she then may select additional colleges, curriculums, courses or modules, or may return 522 to the main menu of university administrator options 501 (see FIG. 5).

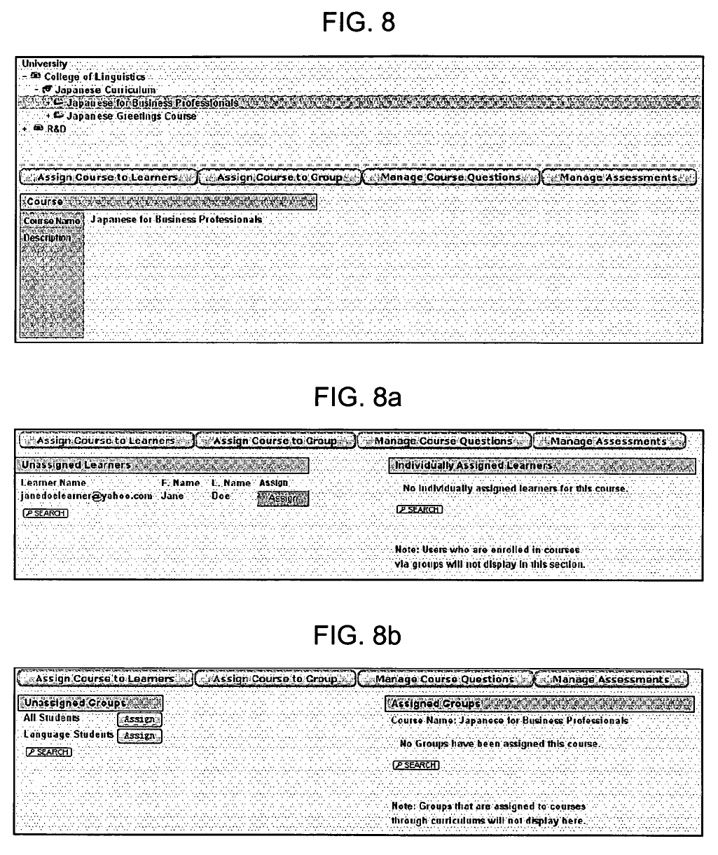

As further shown in FIG. 5a, to manage a course, university administrator first chooses the desired curriculum, as described above, and then selects the desired course 523. The manager portal 3 then displays a list of courses associated with the selected curriculum 524. As shown in FIG. 5b, after selecting a course, university administrator is presented with five options: assign course to learners 525, assign course to group 526, manage course questions 527, manage assessments 528, and return to the course management options 529. The interface presented to the university administrator for these options in the preferred embodiment is shown in FIG. 8. Choosing the assigned course to learners option 525 provides the university administrator the ability to list, add, edit and/or delete learners assigned to the selected course 530 (the interface in the preferred embodiment is shown in FIG. 8a). Similarly, choosing the assigned course to group option 526 provide the university administrator the ability to list, add, edit and/or delete groups assigned to the selected course 531 (the interface in the preferred embodiment is shown in FIG. 8b). Listing, adding, editing and/or deleting learners and/or groups is accomplished in a manner similar to what has been described elsewhere in this disclosure, with manager portal 3 communicating with database 6 using SQL to retrieve, display, and modify the necessary information.

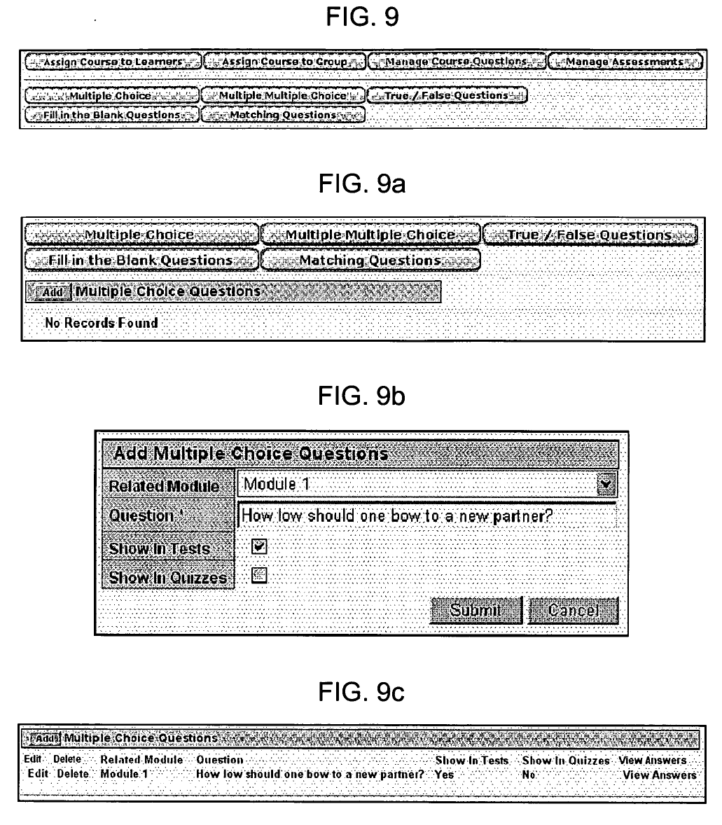

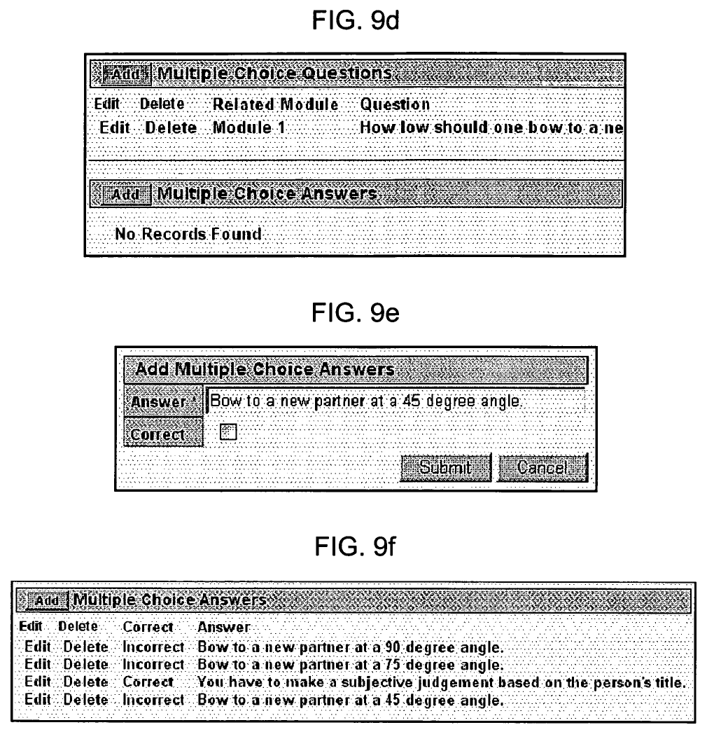

Continuing in FIG. 5b, the university administrator may also choose to manage course questions 527. Selecting to manage course questions 527 causes manager portal 3 to display a course question menu 532. The course question menu presents the university administrator with five options: manage multiple choice questions 533, manage multiple answer questions 534, manage true/false questions 535, manage fill-in-the-blank questions 536, and manage matching questions 537. The user interface of the course question menu 532, in the preferred embodiment, is shown in FIG. 9.

Continuing on FIG. 5b, choosing to manage multiple choice questions 533 causes manger portal 3 to communicate with database 6 to retrieve a list of multiple choice questions for the particular course and to display the questions to the university administrator 538. Similarly choosing to manage multiple answer questions 534 displays a list of multiple answer questions 539; choosing to manage true/false questions 535 displays a list of true/false questions 540; choosing to manage fill-in-the-blank questions 536 displays a list of fill-in-the-blank questions 541; and, choosing to manage matching questions displays a list of matching questions 542. Regardless of the particular question type chosen, university administrator may then choose to manage a particular question (list, add, edit and/or delete), manage the answer to a question, or to return to the main course management menu 543.

Referring again to FIG. 5b, choosing to manage a question 544 gives the university administrator the option to list, add, edit and/or delete the particular question type chosen. Listing, adding, editing and/or deleting questions is accomplished in a manner similar to what has been described elsewhere in this disclosure, with manager portal 3 communicating with database 6 using SQL to retrieve, display, and modify the necessary information. Exemplary interfaces to manage a multiple choice question are shown in FIGS. 9a-9c. The process to manage other question types (multiple answer questions 534, true/false questions 535, fill-in-the-blank questions 536, and matching questions 537 is functionally the same, although the interfaces and data may differ between question types depending on the particular question type. It will be appreciated, however, that such differences fall within the scope of this disclosure and do not substantively affect the operation of the invention disclosed herein.

As shown on FIG. 5b, main course management menu 543 also provides the university administrator with the option to view and manage answers to questions. Choosing to view answers to a question causes manager portal 3 to communicate with database 6 and display answer(s) to the chosen question 545. Depending on the nature of the question, several answers may be associated with a single question (for example, a multiple choice question has one correct answer along with multiple incorrect answers). The University administrator may then choose to manage the answers or return to the course question menu 546. Choosing to manage an answer 547 gives the university administrator the option to list, add, edit and/or delete the particular answer. Listing, adding, editing and/or deleting answer is accomplished in a manner similar to what has been described elsewhere in this disclosure, with manager portal 3 communicating with database 6 using SQL to retrieve, display, and modify the necessary information. Exemplary interfaces (shown for a multiple choice question) are shown in FIGS. 9d-9f. Interfaces for answers to other question types may differ slightly depending on the nature of the particular question type. It will be appreciated, however, that such differences fall within the scope of this disclosure and do not substantively affect the operation of the invention disclosed herein.

When university administrator has completed management of questions and answers, he or she may choose 548 to return to the main course question menu 532 or back to the course selection screen 549 (FIG. 5a).

Continuing in FIG. 5b, the university administrator may also choose to manage assessments (also known as “tests” for the purposes of this disclosure) for a course 528. As shown in FIG. 5c, choosing to manage assessments for a course first causes manager portal 3 to communicate with database 6 to retrieve and display a list of assessments associated with that course 550. The university administrator then chooses 560 whether to manage the assessments 551 or to configure module questions 552.

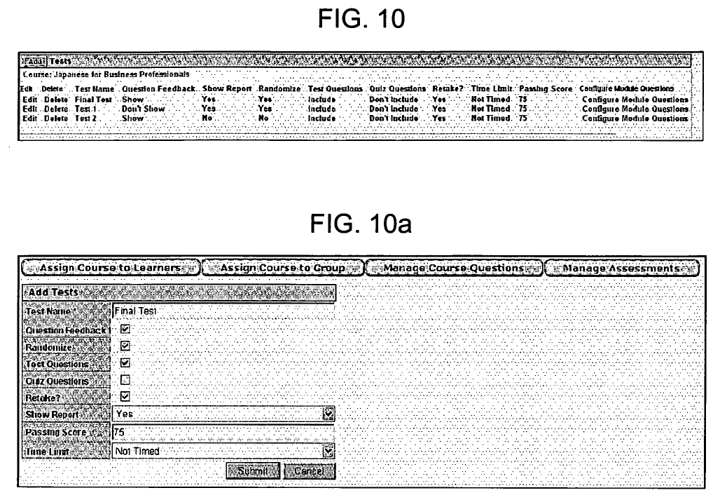

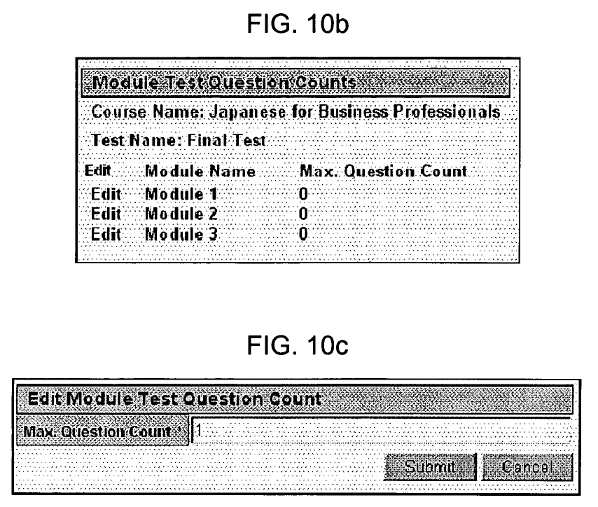

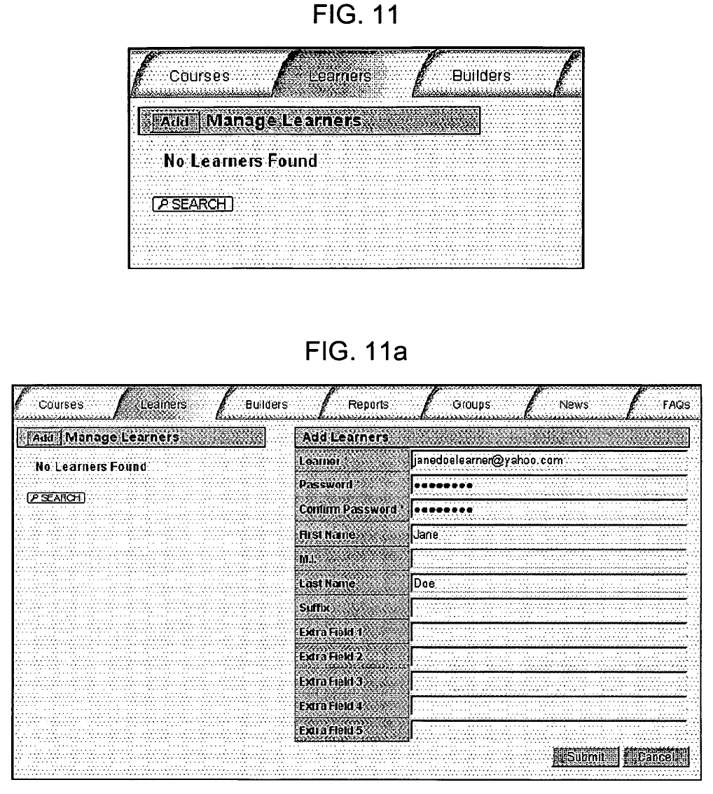

Managing assessments 551 permits the university administrator to list, add, edit and/or delete assessments for a course. Listing, adding, editing and/or deleting assessments is accomplished in a manner similar to what has been described elsewhere in this disclosure, with manager portal 3 communicating with database 6 using SQL to retrieve, display, and modify the necessary information. Exemplary interfaces to manage assessments are shown in FIGS. 10-10a.

Continuing in FIG. 5c, choosing to configure module questions 552 displays a list of modules associated with the chosen course 553 (see FIG. 10b for an exemplary interface). The university administrator then may edit the module question count 554 by selecting the question for which to edit the module question count 555. The manager portal 3 then displays an edit form 556 (an exemplary interface shown in FIG. 10d) and the university administrator makes 557 and confirms 558 the appropriate changes. Once confirmed, manager portal 3 communicates with database 6 to store the updated information 559. After all assessments have been managed and all module questions configured, the university administrator may return to main course menu 524.

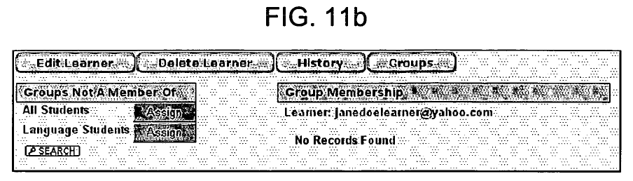

Returning to FIG. 5, manager portal 3 provides the university administrator with several additional functions. Selecting the learners option 504 allows the university administrator to manage learners. Managing learners includes listing, adding, editing, deleting and/or assigning learners to groups. These functions are accomplished in a manner similar to what has been described elsewhere in this disclosure, with manager portal 3 communicating with database 6 using SQL to retrieve, display, and modify the necessary information. The interfaces used in the preferred embodiment to manage learners are shown in FIGS. 11-11b.

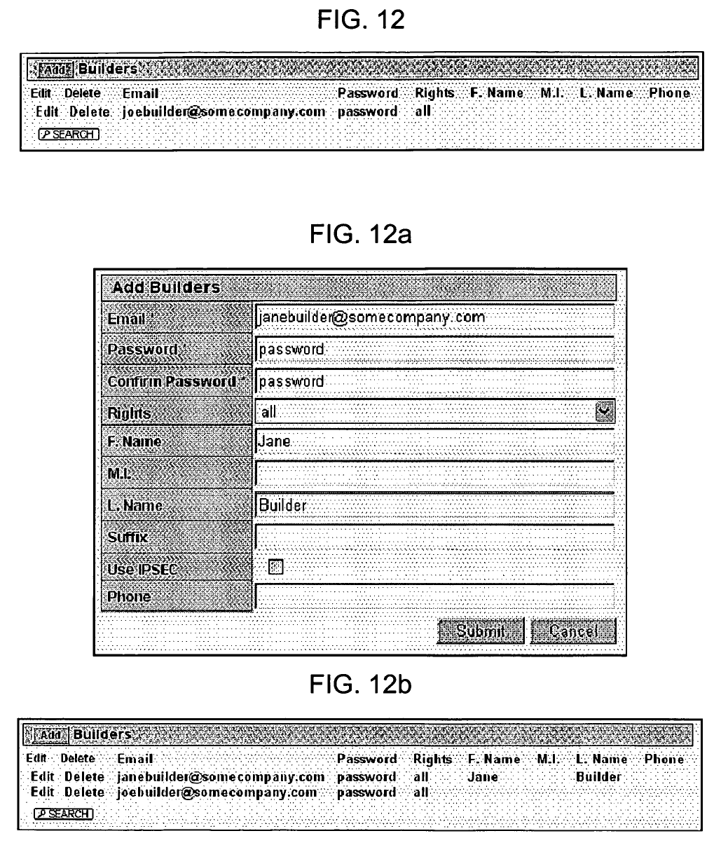

Similarly, again shown in FIG. 5, selecting the builders option 505 allows the university administrator to manage builders. Managing builders includes listing, adding, editing and/or deleting. These functions are accomplished in a manner similar to what has been described elsewhere in this disclosure, with manager portal 3 communicating with database 6 using SQL to retrieve, display, and modify the necessary information. The interfaces used in the preferred embodiment to manage learners are shown in FIGS. 12-12b.

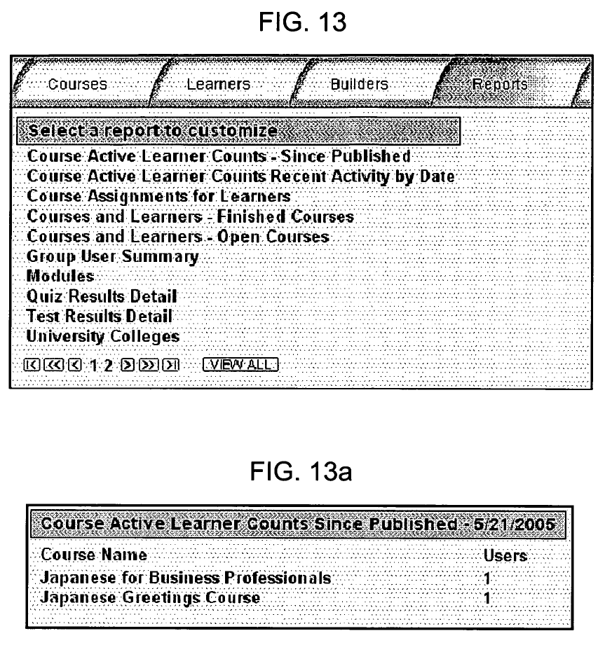

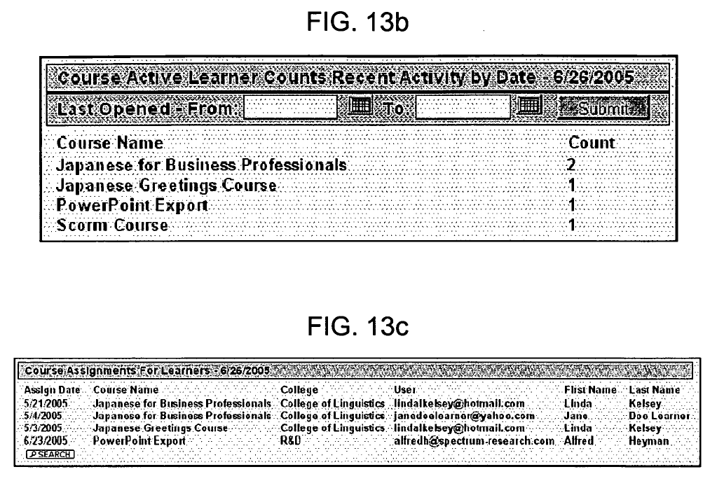

Continuing in FIG. 5, the university administrator may choose the reports option 506. Selecting the reports option 506 provides the university administrator with the option 560 to manage reports or to run reports. Choosing to manage reports 561 allows the university administrator to list, add, edit and/or delete reports. As shown in FIG. 13, such reports include, in the preferred embodiment, course active learner counts, course assignments for learners, finished courses, open courses, group user summaries, modules, quiz results details, test results details, and the like. Managing reports includes listing, adding, editing and/or deleting. These functions are accomplished in a manner similar to what has been described elsewhere in this disclosure, with manager portal 3 communicating with database 6 using SQL to retrieve, display, and modify the necessary information. When the university administrator chooses to run reports 562, the manager portal 3 communicates with database 6 to retrieve and display 563 the information comprising the desired report. Exemplary reports are shown in FIGS. 13a-c. In some embodiments of the web deployed e-learning knowledge management system of the present invention, the reports may be stored for future reference.

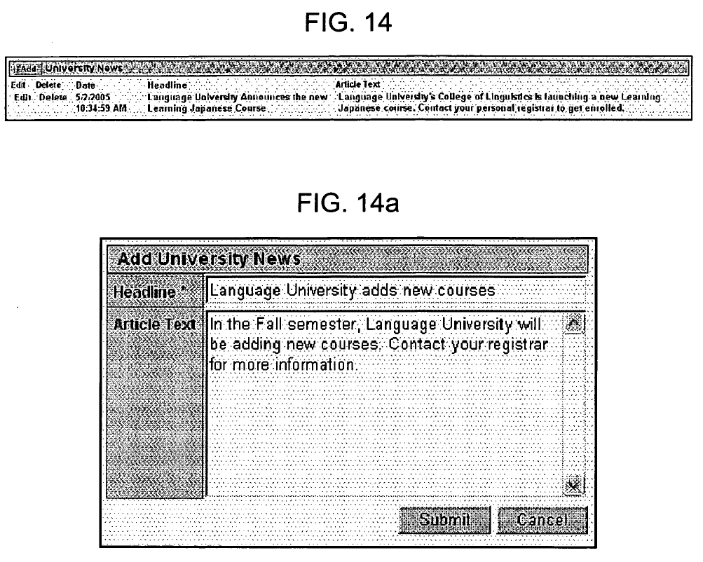

Also shown in FIG. 5, the university administrator may choose the university news option 507. The university news option 507 permits the university administrator to manage news items that will appear to learners. Managing university news includes listing, adding, editing and/or deleting. These functions are accomplished in a manner similar to what has been described elsewhere in this disclosure, with manager portal 3 communicating with database 6 using SQL to retrieve, display, and modify the necessary information. Exemplary interfaces for the university news option 507 are shown in FIGS. 14-14a.

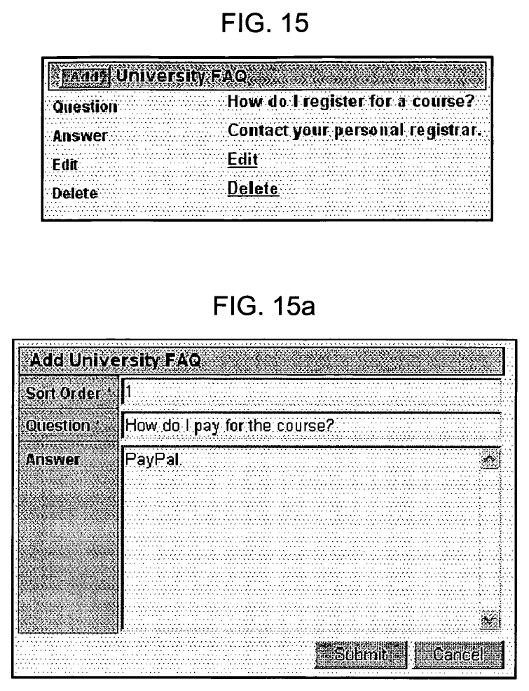

Additionally, as further shown in FIG. 5, the university administrator may choose the university FAQ's option 508. The university FAQ's option 508 permits the university administrator to manage FAQ items that will appear to learners when the learners request help. Managing university FAQ's includes listing, adding, editing and/or deleting. These functions are accomplished in a manner similar to what has been described elsewhere in this disclosure, with manager portal 3 communicating with database 6 using SQL to retrieve, display, and modify the necessary information. Exemplary interfaces for the university FAQ's option 508 are shown in FIGS. 15-15a.

Lastly, as shown in FIGS. 5 and 2, the university administrator may choose the logout option 509 which causes manager portal 3 to close 564 and causes login system 1 to log the university administrator out of the system 105.

Builder Portal

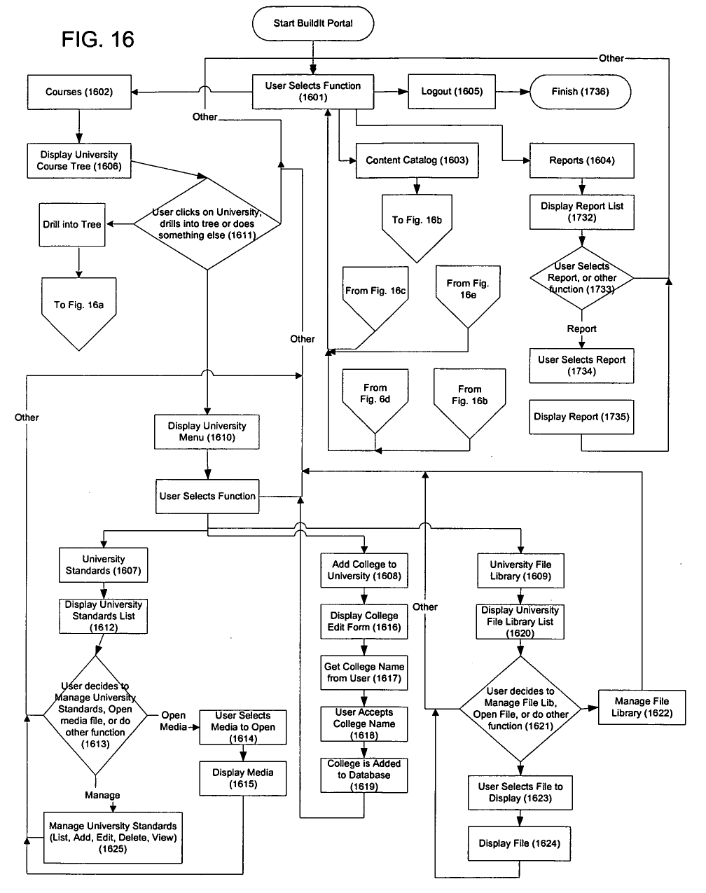

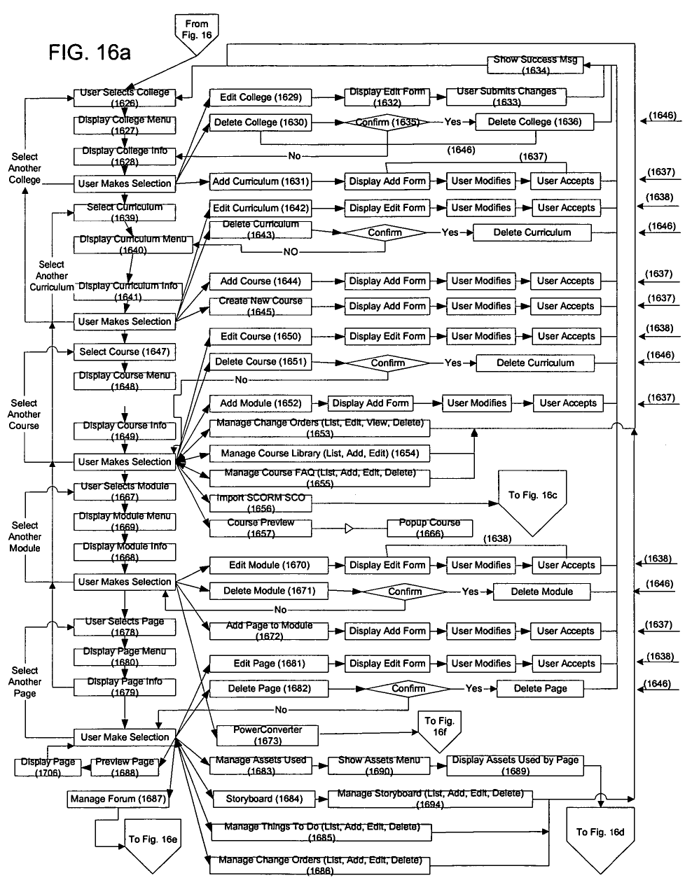

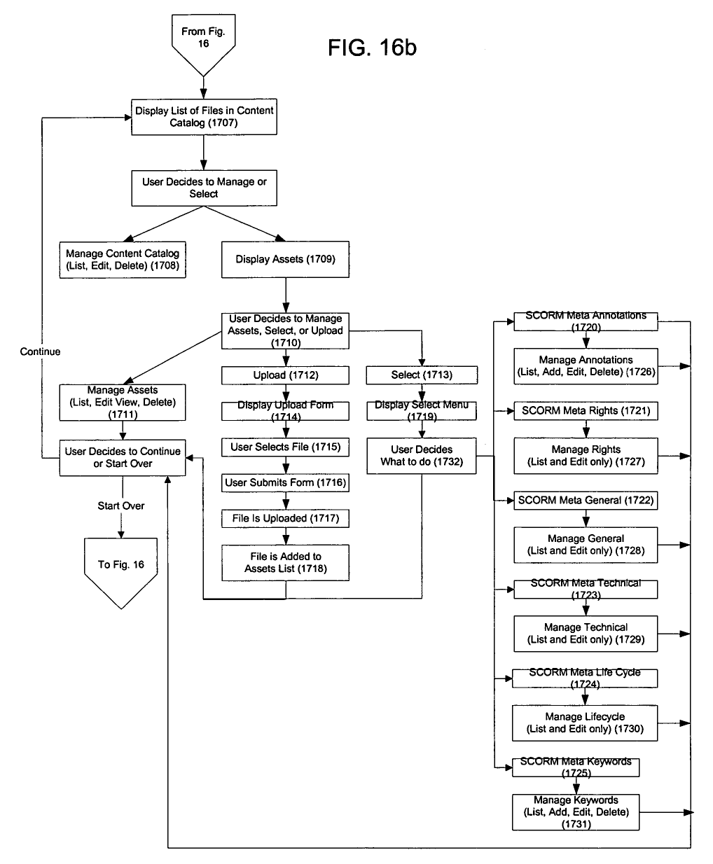

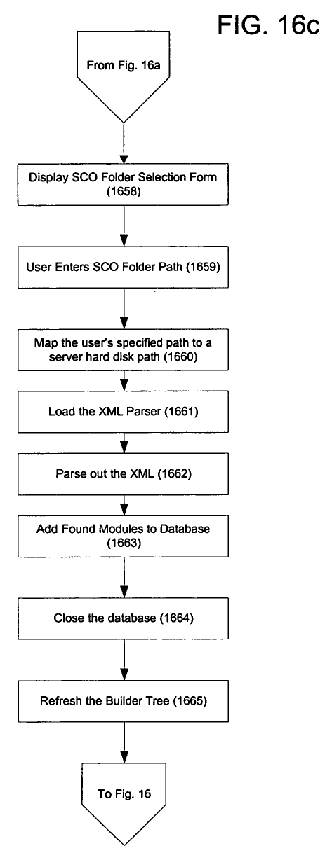

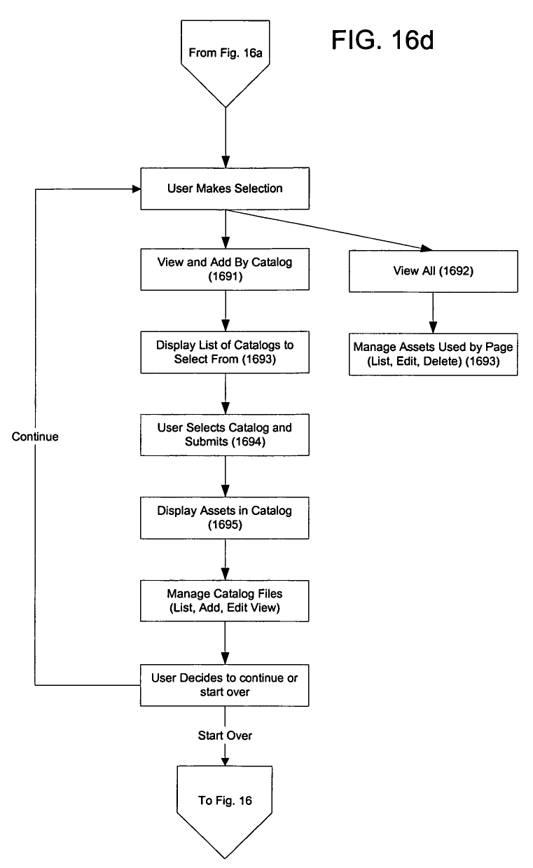

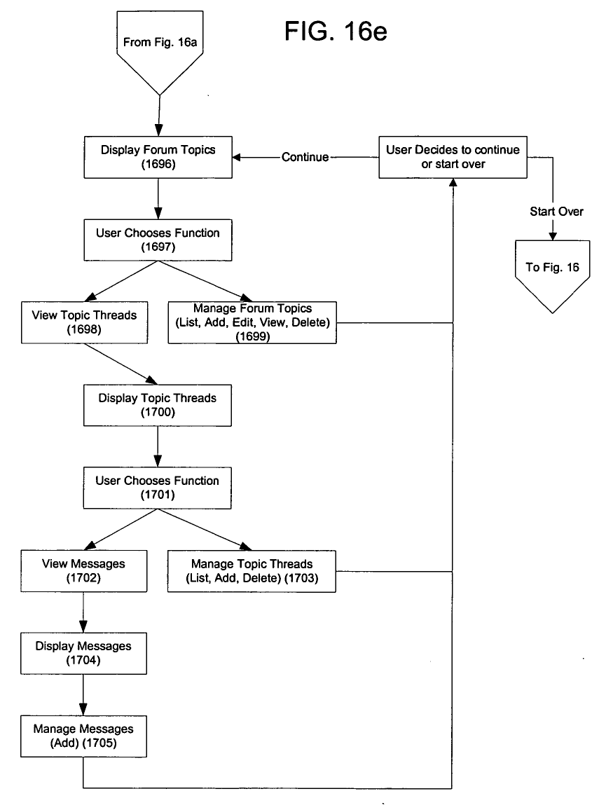

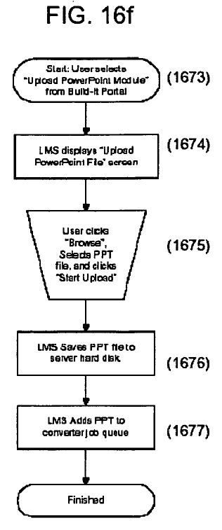

Builder portal 4 is designed to allow course developers (also known as “builders” in this disclosure) to create and deploy e-learning content (also known as “courses”). In the preferred embodiment of the present invention, the general process to build a course is: create a college (or select a new college) in a university, create a curriculum and associate it with a college; create a course and associate with a curriculum; create modules for a course; and, create pages within the modules. As shown in FIG. 16, once a builder accesses builder portal 4 using login system 1 as described above, the builder is presented with a main menu of four builder options 1601: courses 1602, content catalog 1603, reports 1604 and logout 1605.

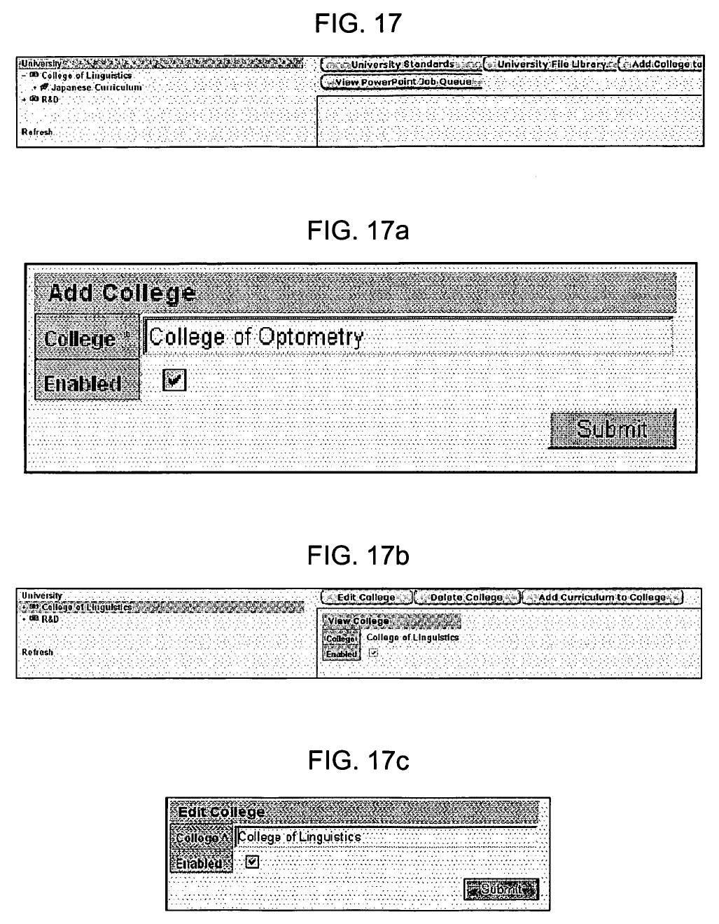

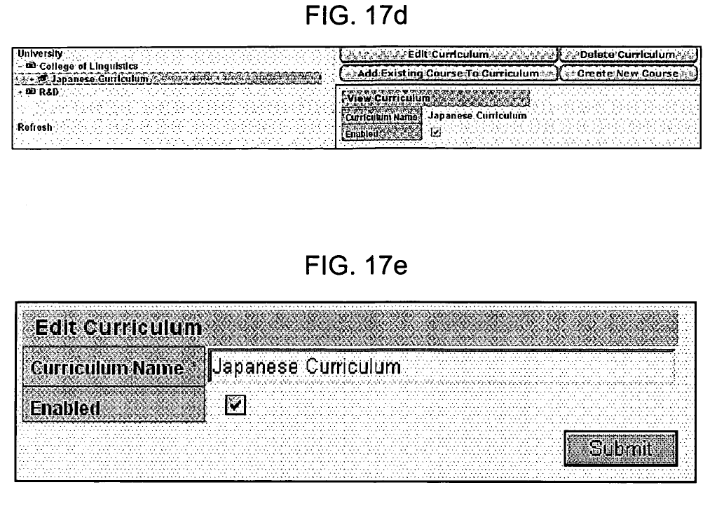

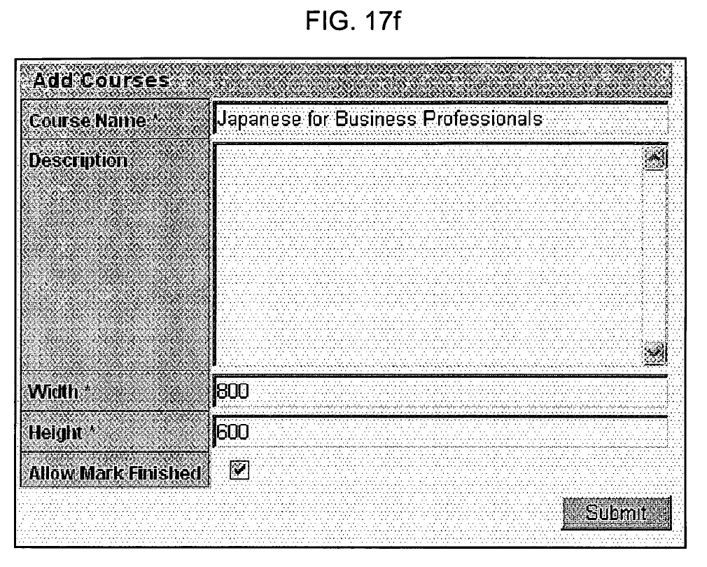

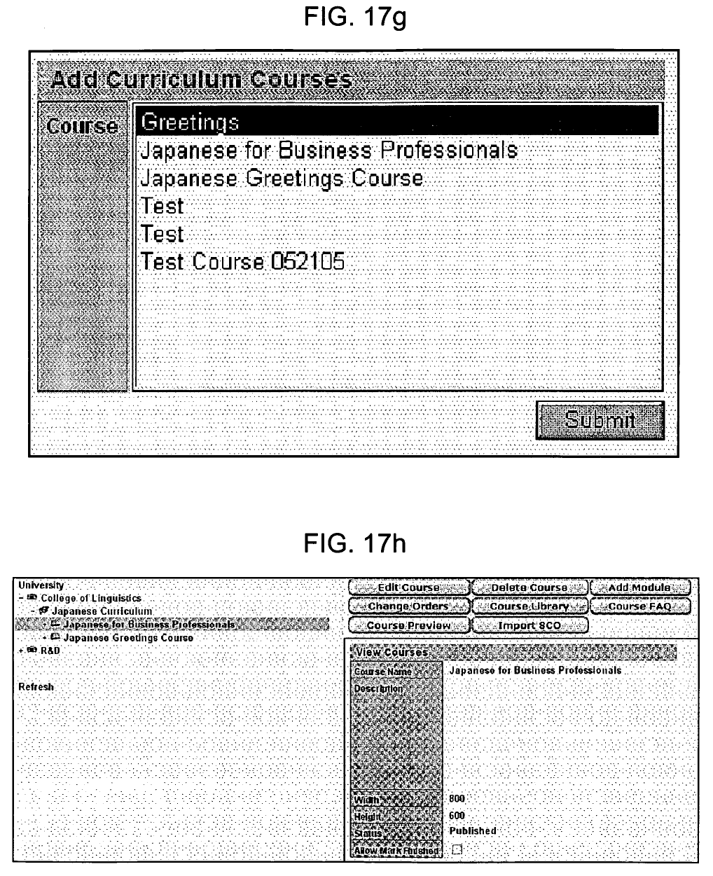

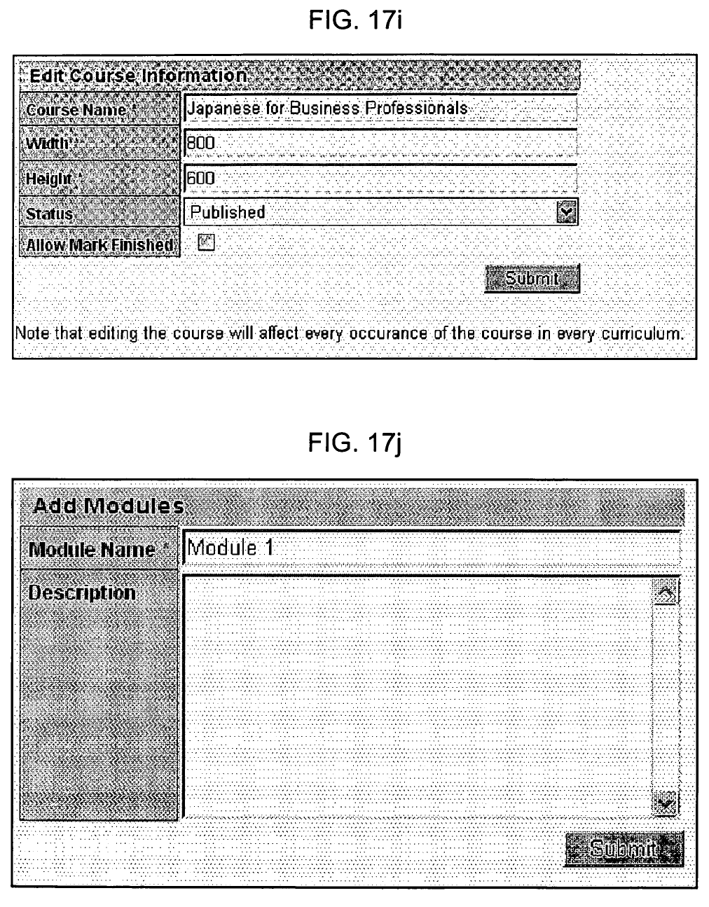

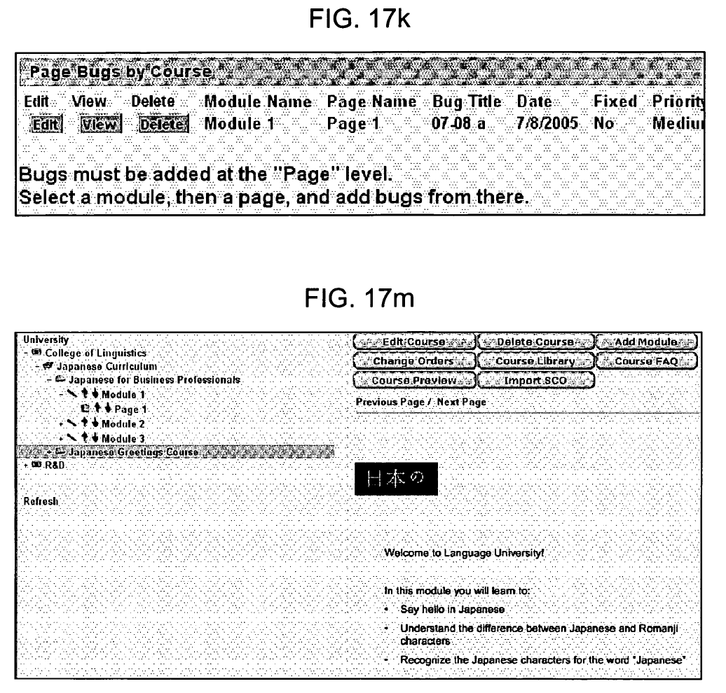

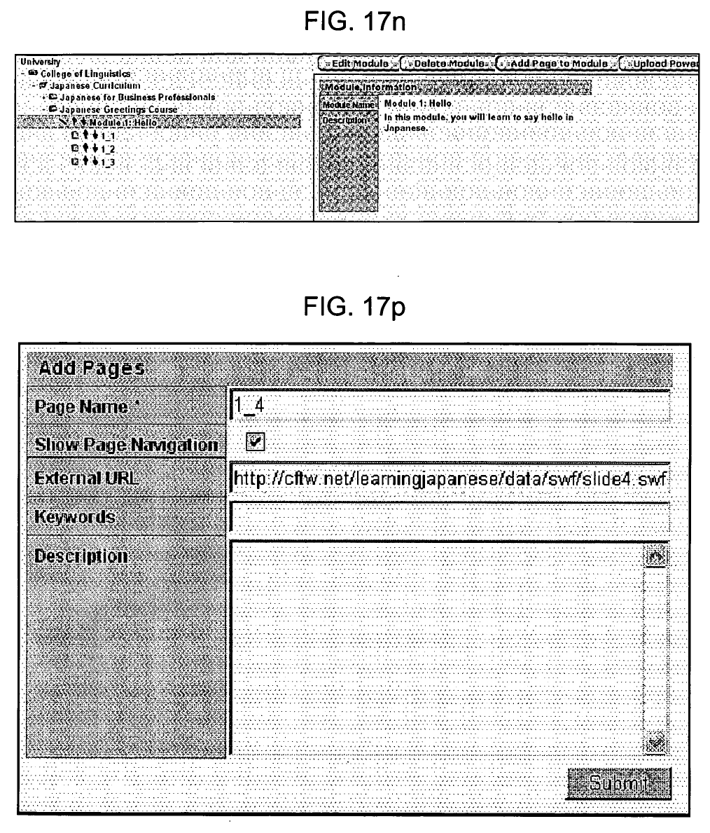

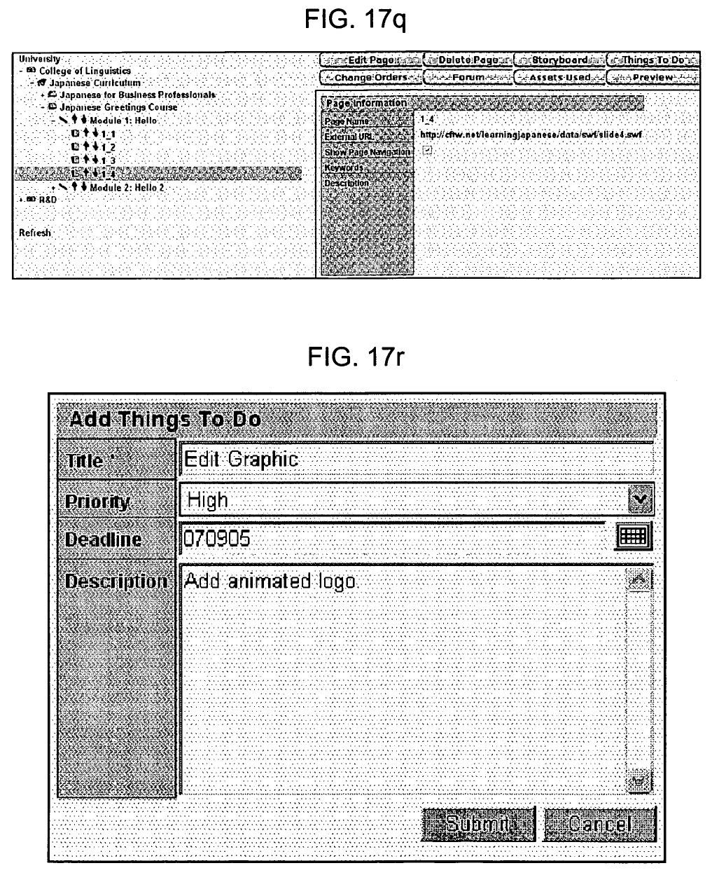

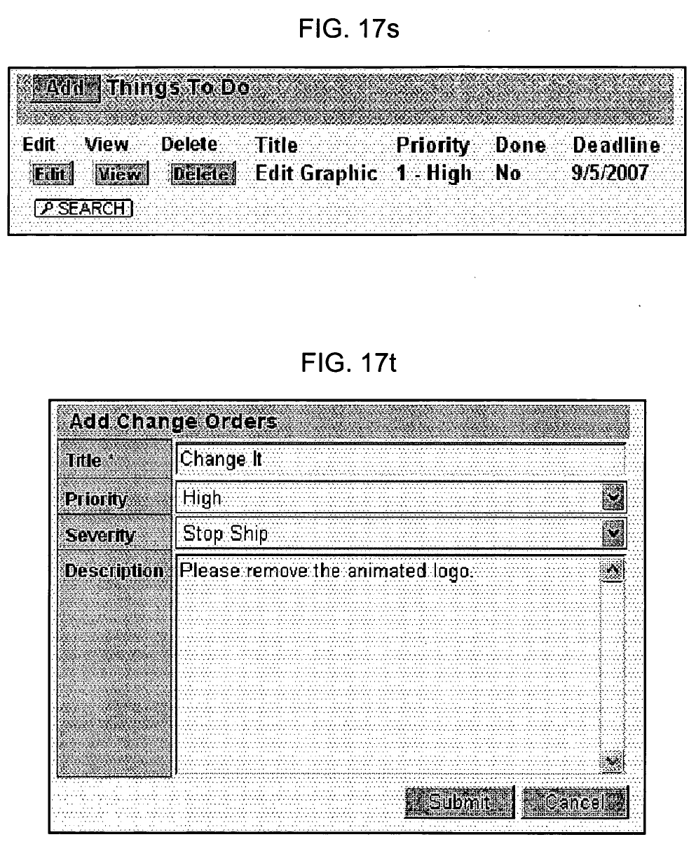

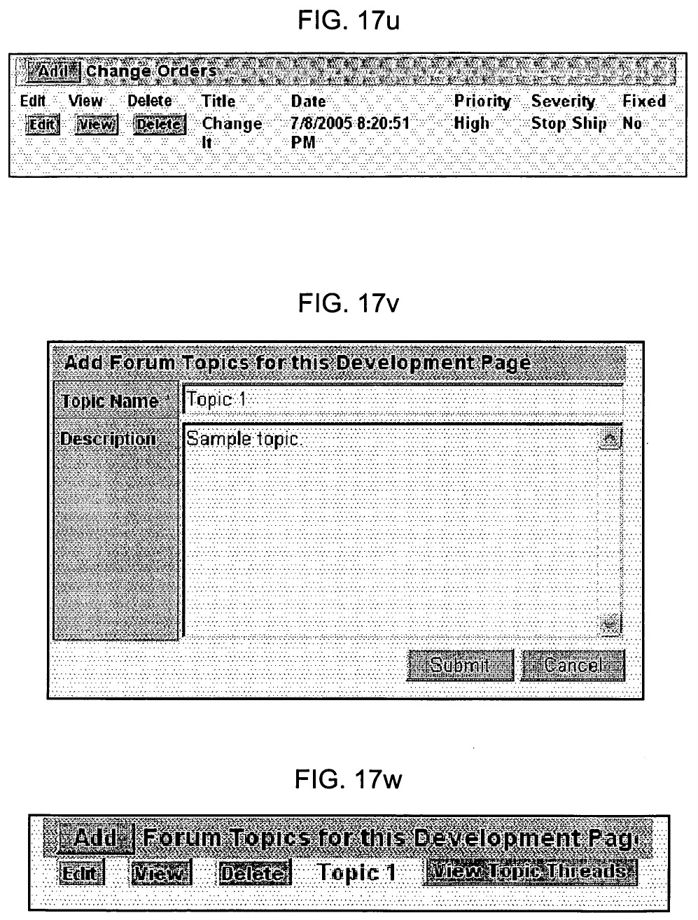

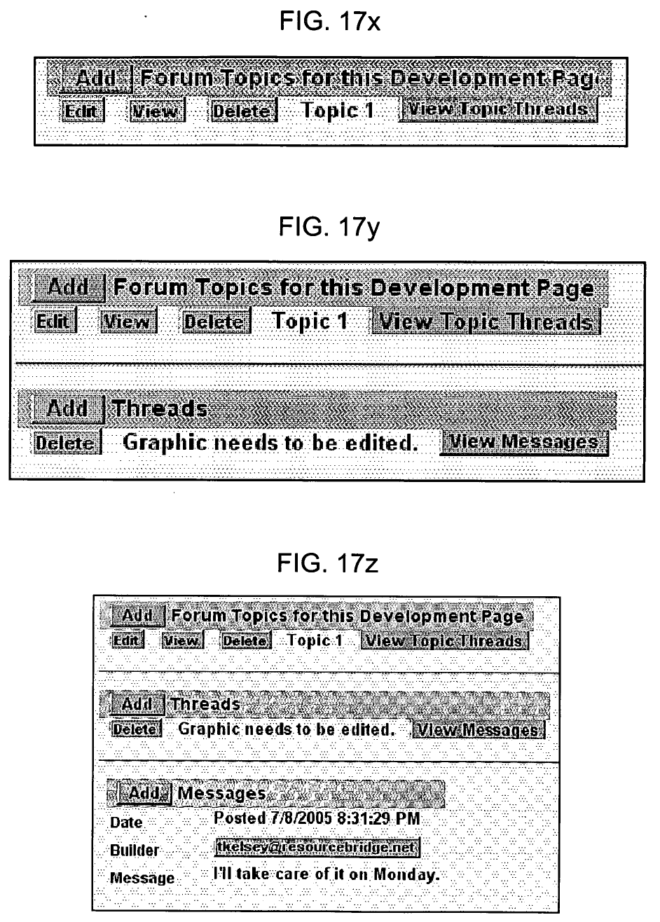

As shown in FIG. 16, choosing the courses option 1601, causes builder portal 4 to communicate with database 6 to retrieve information regarding the university with which the builder is associated. Builder portal 4 then displays to the builder a navigation tree of current university colleges, curriculums, courses, modules and pages 1606 and offers the builder the additional options 1610 of: university standards 1607, add college to university 1608, and university file library 1609. The structure and operation of the navigation tree was discussed earlier in this disclosure. The builder may choose to access exiting colleges, curriculums, courses, modules and pages using the navigation tree, as further discussed below, or may select one of the additional available options 1611. An exemplary interface is shown in FIG. 17.

As further shown in FIG. 16, if the builder chooses the university standards option 1607, builder portal 4 communicates with database 6 to retrieve and display university standards 1612. Builder may then choose to manage university standards or open the associated media files 1613. Choosing to manage university standards 1625 allows builder to list, add, edit, delete and/or view university standards. These functions are accomplished in a manner similar to what has been described several times previously in this disclosure, with builder portal 4 communicating with database 6 using SQL to retrieve, display, and modify the necessary information. Should the builder choose to open the associated media files 1614, builder portal 4 accesses database 6 to retrieve the appropriate files and display the files to the builder 1615. After all university standards have been managed, and all desired media displayed, the builder may return to a main builder menu 1601.

As additionally shown in FIG. 16, choosing the add college to university option 1608 causes the builder portal 4 to display an edit form 1616 (an exemplary interface shown in FIG. 17a). The builder then enters the new college name 1617 and accepts the name 1618. Once accepted, builder portal 5 communicates with database 6 to store the updated information 1619. After all colleges have been added, the builder may return to main builder menu 1601.

The builder may also choose, as shown in FIG. 16, the university file library option 1609. Choosing this option causes builder portal 4 to display a list of file libraries associated with the university 1620. Builder may then choose 1621 to manage the file library 1622 or to select a file to view 1623. Selecting to manage the file library 1622 allows builder to list, add, edit and/or delete file libraries. These functions are accomplished in a manner similar to what has been described several times previously in this disclosure, with builder portal 4 communicating with database 6 using SQL to retrieve, display, and modify the necessary information. Choosing a file to view 1623 causes builder portal 4 to communicate with database 6 using SQL to retrieve, display the file 1624. After the builder has finished managing the file libraries and view files, the builder may return to a main builder menu 1601.

As discussed above, the builder may choose to access exiting colleges, curriculums, courses, modules and pages using the navigation tree. As further shown in FIG. 16a, if the builder selects a college 1626 the builder portal displays information about the college 1628 obtained from database 6 and gives the builder three options 1627: edit the college 1629, delete the college 1630, and add a curriculum to the college 1631. An exemplary interface is shown in FIG. 17b. Choosing to edit a college 1629 causes builder portal 4 to display a form 1632 on which the builder edits the college information. The builder then submits the changes 1633 and the builder portal 4 communicates with database 6 to update the information and displays a confirmatory success message 1634. Choosing to delete a college 1630 causes builder portal 4 to request confirmation of the deletion 1635 before builder portal 4 communicates with database 6 to update the information 1636 and displays a confirmatory success message 1634. Finally, choosing to add a curriculum to the college 1631 causes builder portal 4 to display a form to add the curriculum, accept entry of curriculum data from the builder, and update database 6 with the data upon the builder's acceptance of the data. An exemplary interface is shown in FIG. 17c.

The preceding builder portal process of displaying a form to add data, accepting the entry of new data, updating database 6 with the new data after the builder's acceptance of the data, and displaying a confirmatory success message is repeated throughout FIG. 16a. For ease of reference, it shall be referred to as the “add form process” 1637. Similarly, again for ease of reference, the builder portal process of displaying a form to edit existing data, accepting the entry of edited data, updating database 6 with the edited data after the builder's acceptance of such data, and displaying a confirmatory success message shall be referred to as the “edit form process” 1638. Lastly, for ease of reference, the builder portal process of requesting confirmation of a deletion before builder portal 4 communicates with database 6 to update the deleted information and displaying a confirmatory success message shall be referred to as the “deletion confirmation process” 1646.

As further shown in FIG. 16a, if the builder selects a curriculum 1639 the builder portal 4 displays information about the curriculum 1641 obtained from database 6 and gives the builder four options 1640: edit the curriculum 1642, delete the curriculum 1643, add an existing course to the curriculum 1644 and create a new course for the curriculum 1645. An exemplary interface is shown in FIG. 17d. Choosing to edit a curriculum 1642 causes builder portal 4 to enter the edit form process 1638 to edit the selected curriculum. Choosing to delete a curriculum 1643 causes builder portal 4 to enter the deletion confirmation process 1646 for the selected curriculum. Choosing to add an existing course to the curriculum 1644 causes builder portal 4 to enter the add form process 1637 add the course to the existing curriculum. And, choosing to create a new course for the curriculum 1645 causes builder portal 4 to enter the add form process 1637 to create the new course for the selected curriculum. Exemplary interfaces for these options are shown in FIG. 17e-17g.

Continuing in FIG. 16a, if the builder selects a course 1647 the builder portal 4 displays information about the course 1649 obtained from database 6 and gives the builder eight options 1648: edit the course 1650, delete the course 1651, add a module to the course 1652, manage change orders 1653, manage the course library 1654, manage the course FAQ's 1655, import SCORM SCO 1656, and course preview 1657. An exemplary interface is shown in FIG. 17h. Choosing to edit the course 1650 causes builder portal 4 to enter the edit form process 1638 to edit the selected course. Choosing to delete a course 1651 causes builder portal 4 to enter the deletion confirmation process 1646 for the selected course. Choosing to add a module to the course 1652 causes builder portal 4 to enter the add form process 1637 to add the selected module. Exemplary interfaces are shown in FIG. 17i-17j.

As further shown in FIG. 16a, builder may also choose to manage change orders for courses 1653. Managing change orders, which help identify and report “bugs” in the system, includes listing, editing, viewing and/or deleting change orders. Managing university FAQ's includes listing, adding, editing and/or deleting. These functions are accomplished in a manner similar to what has been described elsewhere in this disclosure, with builder portal 4 communicating with database 6 using SQL to retrieve, display, and modify the necessary information. An exemplary interface for the managing change orders option 1653 is shown in FIG. 17k. Similarly, if the builder chooses the manage course library option 1654, or the manage course FAQ option 1655, as shown in FIG. 16a, builder portal 4 will communicate with database 6 using SQL to retrieve, display, and modify the information necessary for the builder to list, add and/or edit course library information, or list, add, edit and/or delete FAQ's, in a manner similar to what has been described previously in this disclosure.

Additionally, a shown in FIG. 16a, the builder may choose the import SCORM SCO option 1656. As discussed above, SCORM stands for Shareable Content Object Reference Model, a specification for standardizing the reusability and interoperability of learning content for learning management systems. The SCORM standard is well known to those skilled in the art. SCORM utilizes XML (“eXtensible Markup Language”) and JavaScript as standards to define a protocol for application developers to create instructions that can be shared between LMS's. One element of the SCORM standard is Shareable Content Objects (“SCO's”). SCO's are self-contained units of learning that are used as building blocks to create packages of SCO's that then are used by LMS's to present learning content. The preferred embodiment of the present invention is SCORM-compliant; thus, the system is capable of importing SCORM-compliant SCO's.

When the builder chooses the import SCORM SCO option 1656, as shown in FIG. 16c, builder portal 4 displays an SCO folder selection form 1658. Builder then enters the path to the folder (on the builder's local computer) where the SCO content is located 1659. Builder portal 4 then maps the builder's specified path to a path on the builder portal server computer 1660, loads an XML parser 1661, parses out the XML 1662, communicates with database 6 to add the found SCO modules to the database 1663, closes the database 1664, and displays an updated navigation tree to the builder 1665.

Returning the FIG. 16a, the builder's final option under the course menu is the course preview option 1657. Choosing course preview option 1657 causes builder portal 4 to communicate with database 6 to display a preview of the selected course 1666, a helpful tool for builders to use during course development. An exemplary interface for the course preview option 1657 is shown in FIG. 17m.

Continuing in FIG. 16a, if the builder selects a module 1667 the builder portal 4 displays information about the module 1668 obtained from database 6 and gives the builder four options 1669: edit the module 1670, delete the course 1671, add a page to the module 1672 and upload a PowerPoint presentation to use a module 1673. An exemplary interface is shown in FIG. 17n. Choosing to edit the module 1670 causes builder portal 4 to enter the edit form process 1638 to edit the selected module. Choosing to delete a module 1671 causes builder portal 4 to enter the deletion confirmation process 1646 for the selected module. Choosing to add a page to the module 1672 causes builder portal 4 to enter the add form process 1637 to add the selected page to the module. An exemplary interface is shown in FIG. 17p.

Although it is not a necessary element for all embodiments of the present invention, the preferred embodiment of the learning management system of the present invention includes an option for the builder to upload a PowerPoint file to use as a module 1673. This option is quite useful for builders to save time when creating course modules. As is well known in the prior art, and as is becoming more frequent in educational and training settings, instructors prepare presentations using presentation software. Microsoft Corporation's PowerPoint product is by far the most frequently used presentation software. Many course developers integrate PowerPoint presentations into their classes. Thus, the ability to import such existing PowerPoint presentations into the learning management system of the present invention saves course developers significant time since they do not need to recreate the presentations from scratch using the learning management system's native page and module creation tools. The learning management system in the preferred embodiment of the present invention automates the conversion of PowerPoint files to SCORM-compliant modules.

As shown in FIG. 16f, if the builder chooses to upload a PowerPoint file 1673, builder portal 4 displays a PowerPoint folder selection screen 1674. Builder then enters the path to the folder (on the builder's local computer) where the PowerPoint file is located 1675. Builder portal 4 then uploads the PowerPoint file to the builder portal server computer 1676, and adds the PowerPoint file to the queue of PowerPoint files awaiting conversion to SCORM-compliant modules 1677.

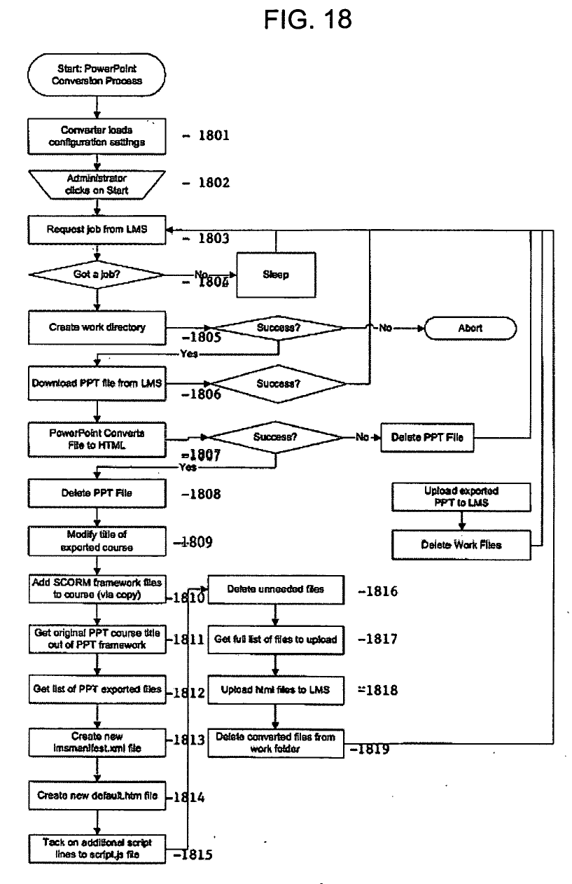

The actual PowerPoint to SCORM-compliant module conversion process is shown in FIG. 18. In the preferred embodiment, the conversion process is handled by a different physical computer than the severs hosting builder portal 4 and database 6 to avoid affecting their operation. However, the computers are networked using traditional prior art networking hardware and protocols to allow the exchange of information between them. As shown in FIG. 18, the conversion process begins when the converter loads its configuration settings 1801 and the conversion administrator clicks on a start button 1802. The converter then communicates with builder portal 4 awaiting notice that a conversion job is waiting 1803. When a conversion job is detected 1804, the converter creates a temporary work directory 1805 and downloads the PowerPoint file from the builder portal 1806. The converter then uses PowerPoint to convert the PowerPoint file to HTML format using PowerPoint's built-in HTML conversion function 1807. Once the PowerPoint file has been successfully converted to HTML format, the converter deletes the original PowerPoint file 1808 and begins modification of the HTML file to make it SCORM-compliant.

Continuing in FIG. 18, the converter then modifies the title of the converted course 1809, adds SCORM framework files to the converted course (using copy) 1810, obtains the original PowerPoint course title out of the converted PowerPoint framework 1811, obtains the list of PowerPoint converted files 1812, creates a new imsmanifest.xml file based on the title and file information 1813, creates a new defaults.htm file with the necessary information 1814, and supplements the scripts.js file as needed 1815. Those skilled in the art of creating SCORM-compliant modules are familiar with the content and purpose of the imsmanifest.xml, defaults.htm, and scripts.js files. As further shown in FIG. 18, the converter then deletes any unnecessary files 1816, determines the full list of converted files needed to upload to the builder portal 1817, and uploads the converted files to the builder portal 1818 which communicates with database 6 to store the files as a new module. The converter then deletes the converted files from the temporary work directory 1819 and awaits notice than another conversion job is waiting 1803.

Returning to FIG. 16a, if the builder selects a page 1678 the builder portal 4 displays information about the page 1679 obtained from database 6 and gives the builder eight options 1680: edit the page 1681, delete the page 1682, manage page assets used 1683, storyboard 1684, manage things to do 1685, manage the change orders 1686, manage forum 1687 and preview page 1688. An exemplary interface is shown in FIG. 17q. Choosing to edit the page 1681 causes builder portal 4 to enter the edit form process 1638 to edit the selected page. Choosing to delete a page 1682 causes builder portal 4 to enter the deletion confirmation process 1646 for the selected page.

As further shown in FIG. 16a, if the builder chooses to manage page assets used 1683, builder portal 4 displays the assets used by the page 1689 obtained from database 6 and gives the builder two options 1690, as shown on FIG. 16d: view and add assets by catalog 1691, and view all assets 1692. If the builder chooses to view and add assets by catalog 1691, the builder portal 4 communicates with database 6 to compile and display a list of catalogs from which to choose 1692. The builder then selects the desired catalog 1693 and the builder portal displays a list of the assets appearing in that catalog 1694. Under this option, the builder also may manage catalog files 1695. Managing catalog files in the preferred embodiment of the present invention includes listing, adding, editing and/or viewing catalogs. These functions are accomplished in a manner similar to what has been described previously in this disclosure, with builder portal 4 communicating with database 6 using SQL to retrieve, display, and modify the necessary information.

Continuing on FIG. 16d, builder may choose to view all assets 1692. Viewing all assets 1692 allows builder to manage all assets used by the selected page 1693. Managing assets includes listing, editing and/or deleting assets. These functions are accomplished in a manner similar to what has been described previously in this disclosure, with builder portal 4 communicating with database 6 using SQL to retrieve, display, and modify the necessary information.

Returning to FIG. 16a, if the builder chooses the storyboard option 1684, the builder can manage the storyboard for the page 1694. Managing the storyboard includes listing, adding, editing and/or deleting storyboards. These functions are accomplished in a manner similar to what has been described previously in this disclosure, with builder portal 4 communicating with database 6 using SQL to retrieve, display, and modify the necessary information.

Continuing in FIG. 16a, the builder may also choose the manage things to do option 1685. Things do to are notes a builder may leave to himself or herself as a reminder to complete a certain task. Managing things to do includes listing, adding, editing and/or deleting things to do. These functions are accomplished in a manner similar to what has been described previously in this disclosure, with builder portal 4 communicating with database 6 using SQL to retrieve, display, and modify the necessary information. Exemplary interfaces are shown in FIGS. 17r-17s.

As further shown in FIG. 16a, builder may choose to manage change orders 1686 for pages. Much like change orders for courses, managing change orders for pages includes listing, adding, editing and/or deleting change orders. These functions are accomplished in a manner similar to what has been described elsewhere in this disclosure, with builder portal 4 communicating with database 6 using SQL to retrieve, display, and modify the necessary information. FIGS. 17t-17u show exemplary interfaces for the managing change orders option 1686.

As further shown in FIG. 16a, the builder may choose to manage forums associated with a page 1687. Forums are designed to be used as a tool by multiple builders working remotely on a team to discuss modifications and content for individual pages. As shown in FIG. 16e, choosing to manage forums associated with a page 1687 causes builder portal 4 display the current forum topics associated with the page 1696 obtained from database 6 and gives the builder two options 1697: view topic threads 1698 and manage forum topics 1699.

Should the builder choose to manage forum topics 1699, builder may list, add, edit, view and/or delete forum topics. These functions are accomplished in a manner similar to what has been described previously in this disclosure, with builder portal 4 communicating with database 6 using SQL to retrieve, display, and modify the necessary information. If the builder chooses to view topic threads 1698, builder portal 4 displays the topic threads for the forum 1700 as obtained from database 6 and presents the builder with two additional options 1701: view messages in a thread 1702 and manage topic threads 1703.

If the builder chooses to view messages in a thread 1702, builder portal 4 communicates with database 6 to obtain and display a list of messages associated with the selected topic thread 1704. The builder then has the option to manage messages 1705, which includes adding a message to the thread. Adding a message to the thread is accomplished in a manner similar to what has been described elsewhere in this disclosure, with builder portal 4 communicating with database 6 using SQL to retrieve, display, and modify the necessary information. Finally, if the builder chooses to manage topic threads 1703, then the builder may list, add and/or delete topic threads. Again, these functions are accomplished in a manner similar to what has been described elsewhere in this disclosure, with builder portal 4 communicating with database 6 using SQL to retrieve, display, and modify the necessary information. Exemplary interfaces for the above identified forum management functions are shown in FIGS. 17v-17z.

Returning again to FIG. 16a, the final option under the page menu is preview page 1688. Should builder choose the preview page option 1688, builder portal 4 will communicate with database 6 to retrieve the assets for the selected page and display a preview of the page to the builder 1706. The preview page option is a helpful feature that allows builders to see how a page will appear before it is available to learners.

Once the builder has completed all desired tasks under the course option 1602, as shown on FIG. 16, the builder is directed back to the main menu of builder options 1601. Choosing the content catalog option 1603 causes builder portal 4 communicate with database 6 to display a list of files in the content catalog 1707. The content catalog is a centralized method to manage assets. Builder is the presented with two options: manage the content catalog 1708 or display assets 1709. If the builder chooses to manage the content catalog 1708, then the builder may list, edit and/or delete catalogs. Again, these functions are accomplished in a manner similar to what has been described elsewhere in this disclosure, with builder portal 4 communicating with database 6 using SQL to retrieve, display, and modify the necessary information. Alternatively, if the builder chooses to display assets 1709, builder portal 4 offers three new options 1710: manage assets 1711, upload assets 1712 and select assets 1713.

If the builder chooses to manage assets 1711, then the builder may list, edit, view and/or delete assets. Again, these functions are accomplished in a manner similar to what has been described elsewhere in this disclosure, with builder portal 4 communicating with database 6 using SQL to retrieve, display, and modify the necessary information. If the builder chooses to upload assets 1712, the builder portal 4 then displays an upload form 1714 and builder then enters the path to the folder (on the builder's local computer) where the asset is located 1715. Builder then submits the upload form to the builder portal 1716 and builder portal 4 uploads the asset from the builder's computer 1717 and communicates with database 6 to add the found SCO modules to the database 1718.

Lastly, if builder chooses the select assets option 1713, builder portal 4 displays a list of six options 1719 for the builder to select 1732 for managing SCORM attributes of the selected asset: manage SCORM META annotations 1720, manage SCORM META rights 1721, manage SCORM META general 1722, manage SCORM META technical 1723, manage SCORM META life cycle 1724 and manage SCORM META keywords 1725. Those skilled in the art of the SCORM standard are familiar with these SCORM attributes and, thus, this disclosure will not discuss the attributes in depth. Choosing to manage SCORM META annotations 1720 allows the builder to list, add, edit and/or delete META annotations 1726. Choosing to manage SCORM META rights permits the builder to list and/or edit META rights 1727. Choosing to manage SCORM META general allows the builder to list and/or edit META general attributes 1728. Choosing to manage SCORM META technical permits the builder to list and/or edit META technical attributes 1729. Similarly, choosing to manage SCORM META life cycle allows the builder to list and/or edit META life cycle attributes 1730. Finally, choosing to manage SCORM META keywords permits the builder to list, add, edit and/or delete META keyword attributes 1731. It will be appreciated that management of all of the foregoing SCORM META attributes is accomplished in a manner similar to what has been described previously in this disclosure, with builder portal 4 communicating with database 6 using SQL to retrieve, display, and modify the necessary information.

Returning to FIG. 16, once the builder has completed all desired tasks under the content catalog option 1603, as shown on FIGS. 16 and 16b, the builder is directed back to the main menu of builder options 1601.

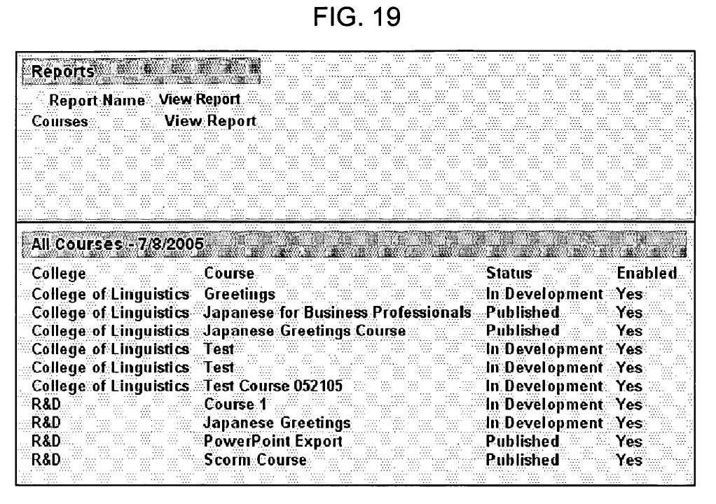

Choosing the reports option 1604 causes builder portal 4 communicate with database 6 to display a list of available builder reports 1732. Builder may then select a report or return to the main menu of builder options 1733. If builder selects a report 1734, builder portal 4 communicates with database 6 to retrieve and display the data required by the report 1735. After the report has been displayed, the builder may then return to the main menu of builder options 1601. An exemplary report interface is shown in FIG. 19. In some embodiments of the web deployed e-learning knowledge management system of the present invention, the reports may be stored for future reference.

Lastly, as shown in FIGS. 16 and 2, the builder may choose the logout option 1605 which causes builder portal 4 to close 1736 and causes login system 1 to log the builder out of the system 105.

Learner Portal

As summarized above, learner portal 5 is designed to allow a learner to view courses available to the learner, register for courses, take courses, complete online assessments, and track personal history. The learner portal also provides access to supplemental course materials, such as course syllabi, schedules, required reading, and the like. It will be appreciated that the term “learner” as used throughout this disclosure refers to students, employees, or any other entity similarly situated that uses the system for education and/or training purposes.

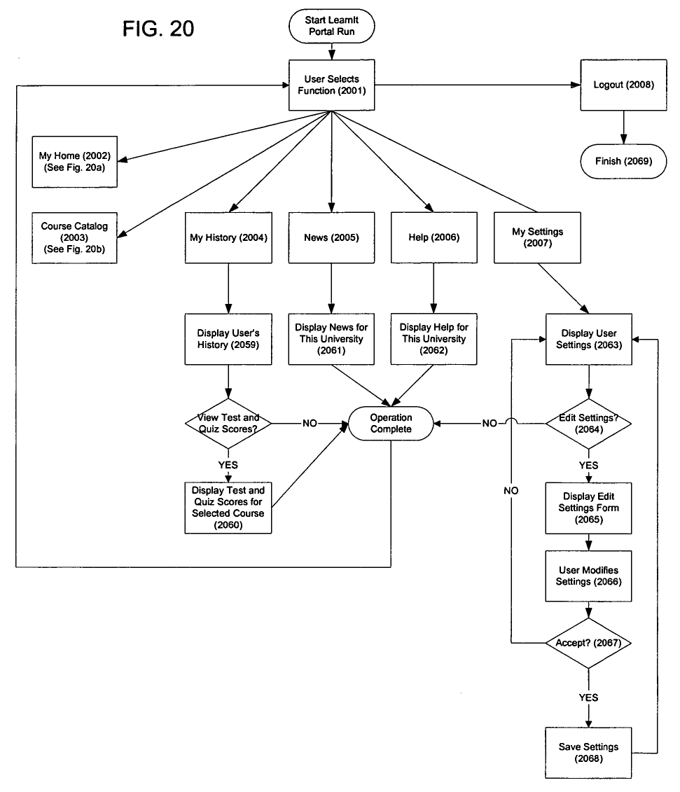

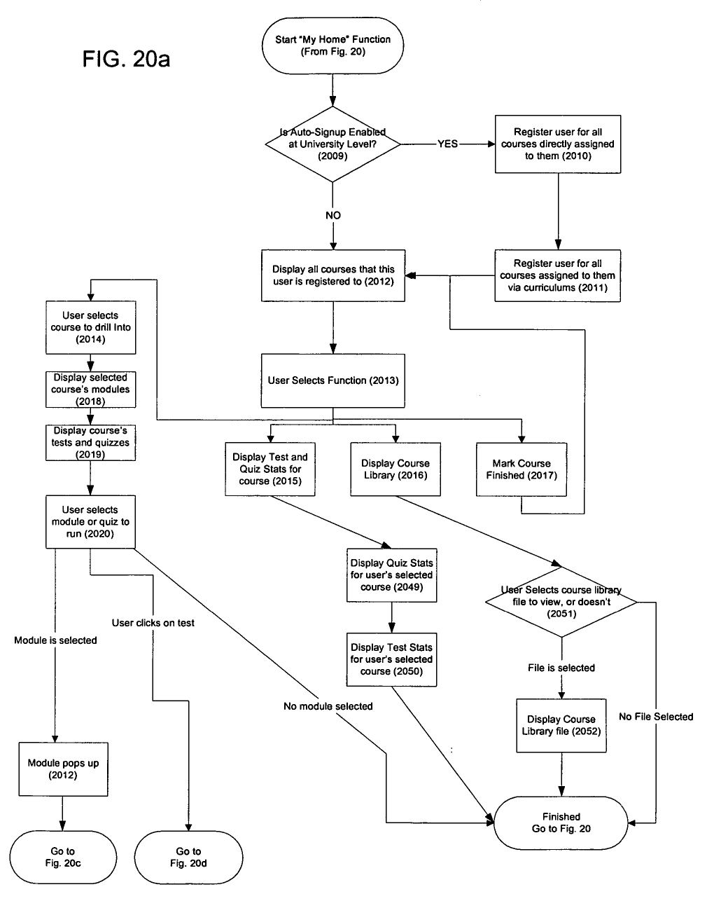

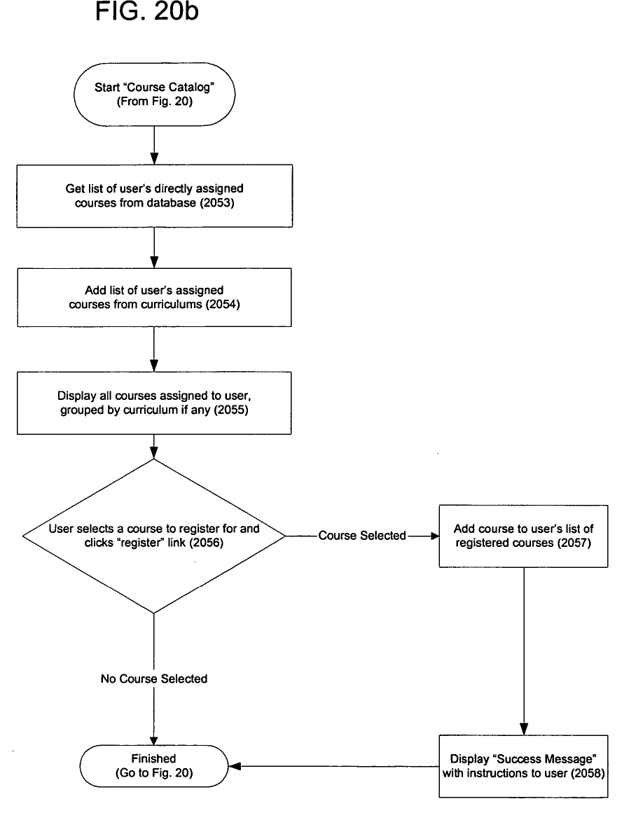

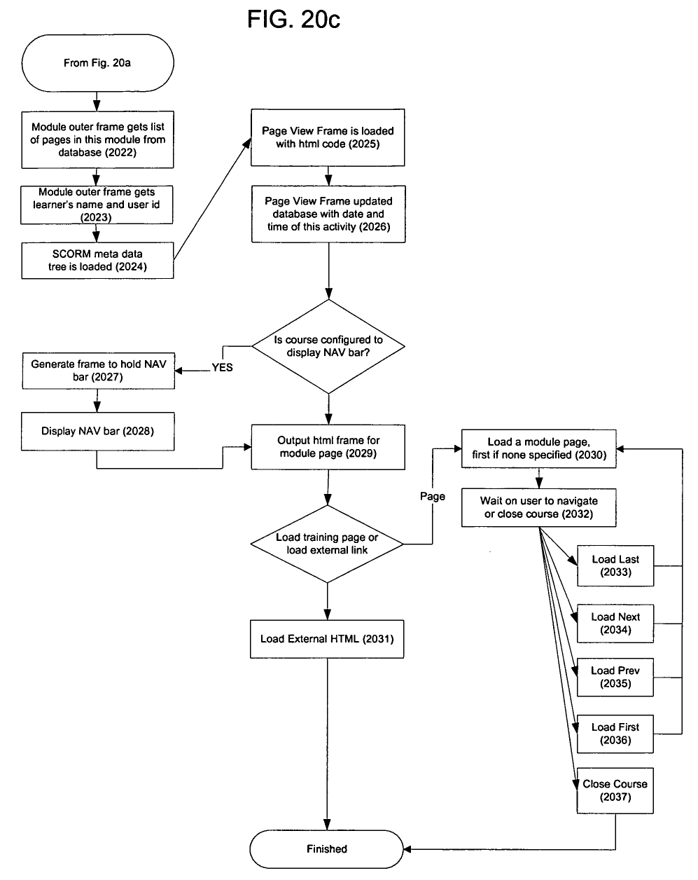

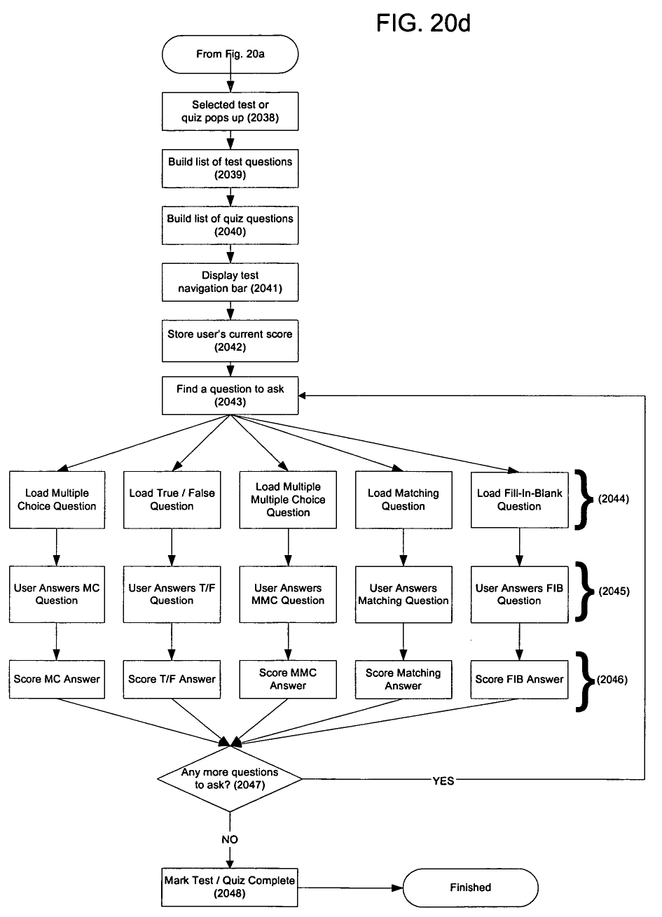

As shown in FIG. 20, once a learner accesses learner portal 5 using login system 1 as described above, the learner is presented with a main menu of seven learner options 2001: my home 2002, course catalog 2003, my history 2004, news 2005, help 2006, my settings 2007 and logout 2008.

In the preferred embodiment of the present invention, a university, through the manager portal 3, may permit auto-signup of learners into assigned courses, thereby eliminating the need for learners to manually register for each course. Thus, as shown in FIGS. 20 and 20a, if a learner chooses the my home option 2002, learner portal 5 to communicates with database 6 to determine whether the particular university has enabled auto-signup of for its learners 2009. If auto-signup has been enabled, learner portal 3, in communication with database 6, automatically registers the learner for all courses that have been directly assigned to the learner 2010, as well as all courses that have been assigned to the learner indirectly through a curriculum 2011. If auto-signup has not been enabled by a particular university, the learner will have to manually register for courses as further discussed below.

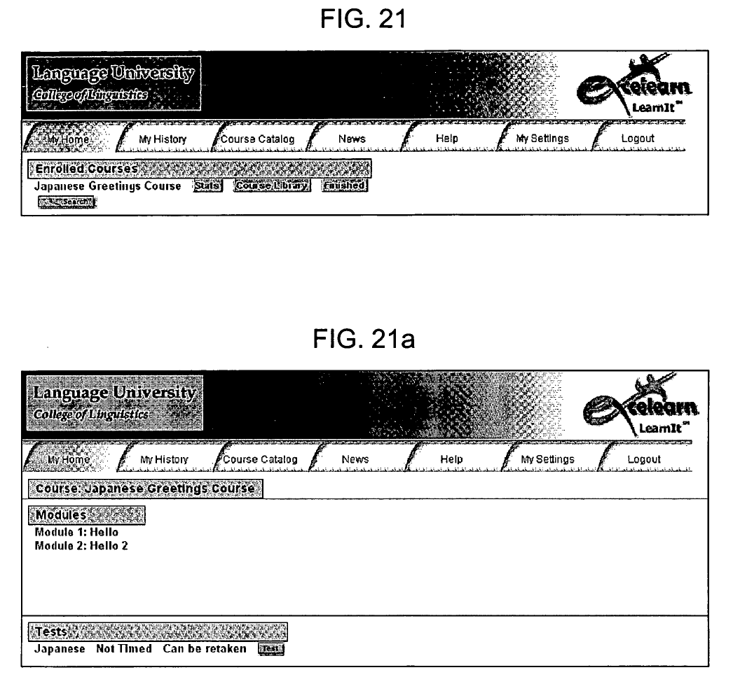

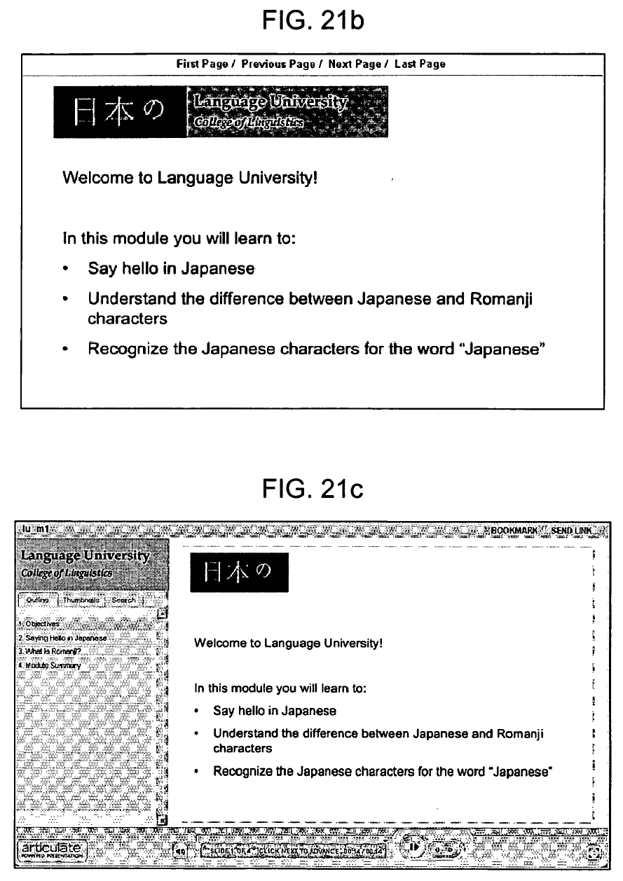

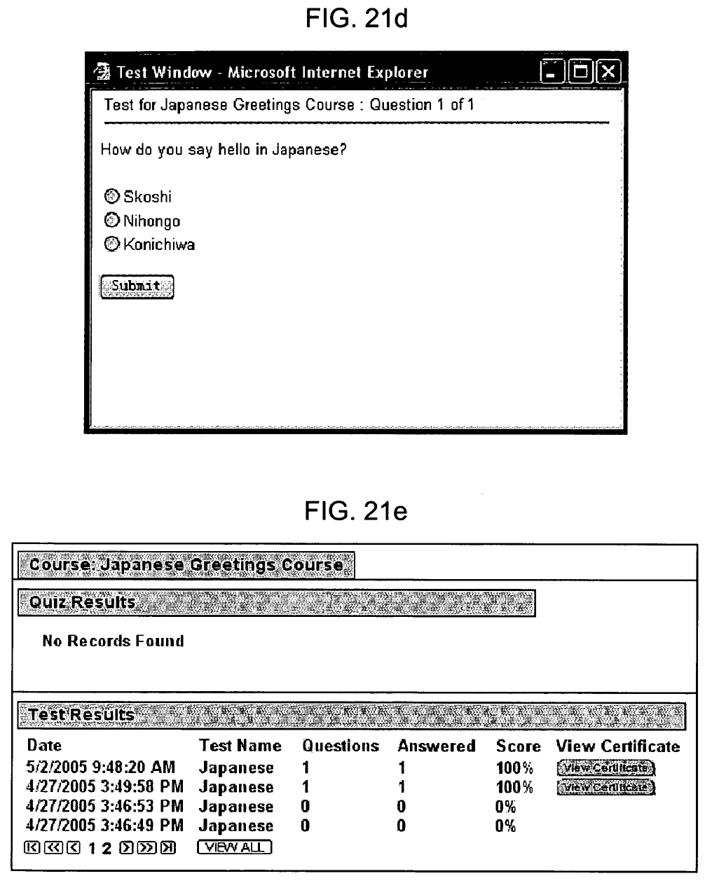

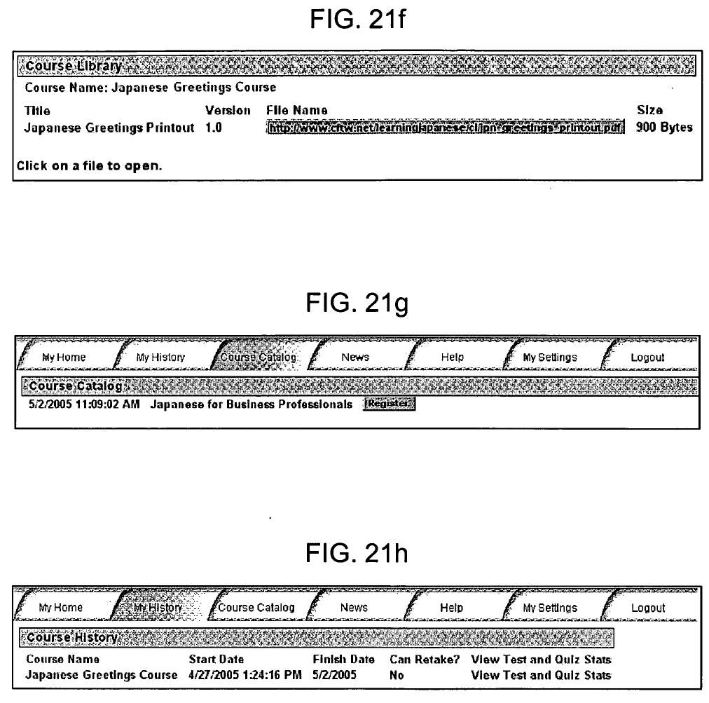

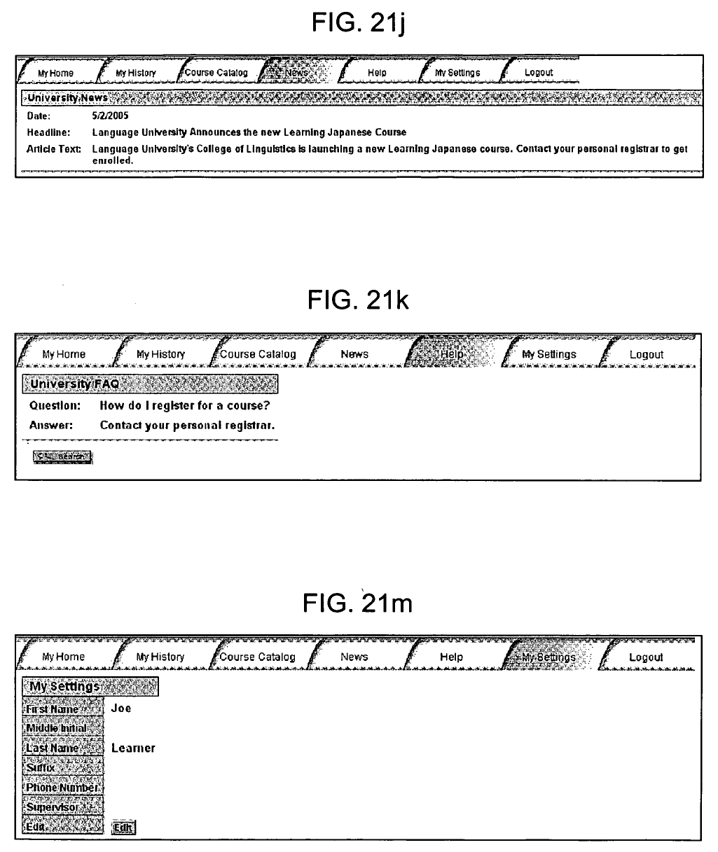

As further shown in FIG. 20a, learner portal 5 then receives from database 6 and displays a list of all courses for which the learner is registered 2012. The learner is then presented with a four options for each course 2013: enter course 2014, display course test and quiz stats 2015, display course library 2016, and mark course finished 2017. An exemplary interface is shown in FIG. 21.

If the learner chooses to enter a course 2014, the learner portal 5 communicates with database 6 to retrieve and display the selected course's modules 2018 and the course's tests and quizzes 2019. The learner may then choose to view a module or run a test or quiz 2020. An exemplary interface is shown in FIG. 21a.

If the learner chooses to view a module, learner portal 5 communicates with database 6 to receive and display the module's content (pages and assets) 2021, as further outlined in FIG. 20c. As shown in FIG. 20c, first the module's outer frame obtains a list of the pages in the module from the database 2022, and obtains the learner's name and user ID 2023. Next, the SCORM META data tree is loaded 2024 and the page view frame is loaded with HTML code 2025. Additionally, the page view frame updates the database 6 with the date and time that the module is being viewed by the learner 2026. Next, if the course if configured to display with a navigation bar, a frame is generated to hold the navigation bar 2027 and then navigation bar is displayed 2028. If the course is not configured to display with a navigation bar, this step is skipped. The learner portal 4 next outputs the HTML frame for the module page 2029 and either loads the module page from the database 2030 or loads an external HTML page 2031, depending on how the module was created. If the module uses internal pages from the database 6, then the learner portal 5 waits for the learner to navigate through the module pages 2032. In the preferred embodiment of the present invention, the learner may: load the last page in the module 2033, load the next page in the module 2034, load the previous page in the module 2035, load the first page in the module 2036 or close the course 2037. Exemplary interfaces showing modules using internal pages and external HTML are shown in FIGS. 21b and 21c, respectively.

Returning to FIG. 20a, after completing the course modules, the learner may choose to run a test or quiz. As shown in FIG. 20d, when the learner selects a test or quiz, the learner portal 5 opens a new window for the test or quiz 2038, communicates with database 6 to obtain and build a list of test questions 2039 and quiz questions 2040 for the selected course, displays a test navigation bar in the test window 2041, stores the learner's current score for the test (if any) 2042, and finds the test or quiz questions programmed by the builder to be asked to learners for the selected course 2043. The builder portal then loads and displays to the learner, one-by-one, the programmed questions (which may be multiple choice, true/false, multiple multiple choice (also called “multiple answer”), matching and/or fill-in-the-blank questions) 2044. The learner then answers the questions one-by-one 2045 and the learner portal 5 records and scores the learner's answers to the questions 2046. Once all programmed test or quiz questions for the selected course have been answered 2047, the test or quiz is marked as completed for the learner 2048 and the test or quiz score information is communicated to database 6. An exemplary test interface is shown in FIG. 21d.

Returning to FIG. 20a, the learner may choose to display test and quiz stats for a course 2015. Selecting this option causes learner portal 5 to communicate with database 6 to retrieve and display test 2049 and quiz 2050 statistics for the selected course. An exemplary display of test and quiz statistics under this option is shown in FIG. 21e. Continuing in FIG. 20a, the learner may also choose the display course library option 2016. The course library displays any materials that the course builder has included for a learner to access, such as job aids, print outs and reference guides. Choosing the display course library option 2016 presents of list of materials for the selected course 2051. The learner then chooses which material to view and the learner portal displays the material for the learner's reference 2052. An exemplary course library interface is shown in FIG. 21f.

In the preferred embodiment of the present invention, the learner may also choose to mark a course finished 2017, if the course builder enabled this feature when the course was created. When a course has been marked finished, it will no longer appear in the learner's list of courses. As shown in FIG. 20a, when the learner is done entering course 2014, displaying course test and quiz stats 2015, displaying course libraries 2016 and marking courses finished, the learner is returned to the main learner menu 2001 as shown in FIG. 20.

Returning to FIG. 20, the learner may also choose the course catalog option 2003. As shown in FIG. 20b, the course catalog option allows a learner to view and, if necessary, register for courses that have been assigned to the learner. Selecting the course catalog option 2003 causes learner portal 5 to communicate with database 6 to obtain a list of all courses that have been directly assigned to the learner 2053, as well as all courses that have been assigned to the learner indirectly through a curriculum 2054. The learner portal 5 then displays all of the assigned courses to the learner, grouped by curriculum, if any 2055. The learner then may choose from the list of assigned courses any courses for which the learner needs to register 2056, and builder portal 5 adds the courses to the learner's list of registered courses 2057 through communication with database 6. After the learner has been successfully registered for a course, the builder portal displays a confirmatory success message 2058. Once the learner has completed registration for all desired courses, the learner is directed back to the main learner menu 2001 (FIG. 20). An exemplary course catalog interface is shown in FIG. 21g.

Returning, again, to FIG. 20, the learner can also choose the my history option 2004. The my history option 2004 displays a history of courses taken and their completion dates 2059, as retrieved by learner portal 5 from database 6, and gives the learner the option to view the learner's test and quiz stats from the completed courses 2060, also retrieved by the learner portal 5 from database 6. An exemplary my history interface is shown in FIG. 21h. Continuing in FIG. 20, the learner may choose the news option 2005. News option 2005 causes learner portal 5 to communicate with database 6 to retrieve and display 2061 any university news as entered by the university administrator using the manager portal 3 as previously discussed. An exemplary news option interface is shown in FIG. 21j. Similarly, as shown in FIG. 20, the learner may choose the help option 2006. Help option 2006 causes learner portal 5 to communicate with database 6 to retrieve and display 2062 any university FAQ's as entered by the university administrator using the manager portal 3 as previously discussed. An exemplary help option interface is shown in FIG. 21k.

Again returning to FIG. 20, the learner may choose the my settings option 2007. Choosing the my settings option 2007 causes learner portal 5 to communicate with database 6 and receive and display the learner's current settings 2063. In the preferred embodiment, as shown in the exemplary my settings interface in FIG. 21m, a learner's settings include: the way the learner's name is displayed, the learner's phone number, and the learner's supervisor. After viewing his or her current settings, the learner may choose to edit the settings 2064. The learner portal then will display an edit settings form 2065 on which the learner may modify the settings 2066. When the learner accepts the changed settings 2067, learner portal 5 communicates the changed information to database 6 where it is saved 2068.

Lastly, as shown in FIGS. 20 and 2, the learner may choose the logout option 2008 which causes learner portal 5 to close 2069 and causes login system 1 to log the learner out of the system 105.

Database

Database systems and structures are well known in the prior art, and the database system and structure used in the present invention are well tested and reliable. In the preferred embodiment, database 6 is created using Microsoft SQL Server 2000 software and is stored on an independent database server computer. Database 6 comprises a plurality of database tables used to store the various data related to the four portals and the login system of the present invention. Database 6 is a normalized relational database wherein the database is programmed to store effectively different, but related, data which are able to be retrieved and changed as necessary by the portals and login system using a standardized communication protocol, namely Structured Query Language (“SQL”).

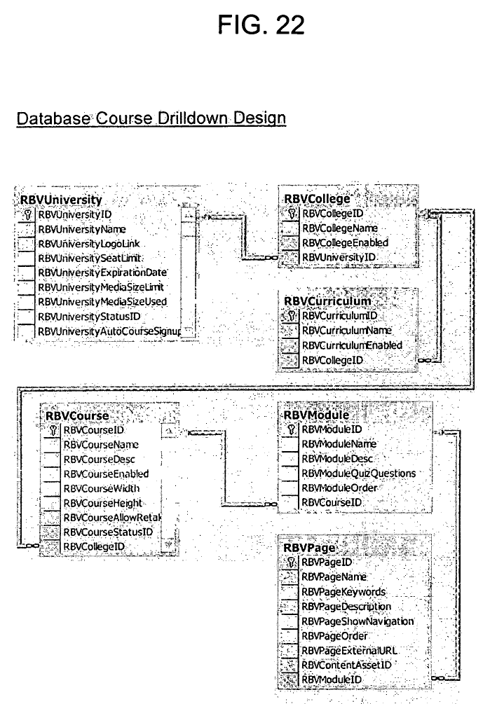

The precise design and structure of the database is not critical to the operation of the present invention, and any suitable database created by one skilled in the art can be used to store the data used by the four portals and login system. Nevertheless, in the preferred embodiment of the present invention, database 6 comprises 64 database tables. By way of example, FIGS. 22-26 show some of the data stored in the database tables in the preferred embodiment of the present invention and as well as the relational nature of the database tables. These relational database designs depicted in these figures is well known to those skilled in the art and this disclosure will only summarize the general content of the figures.

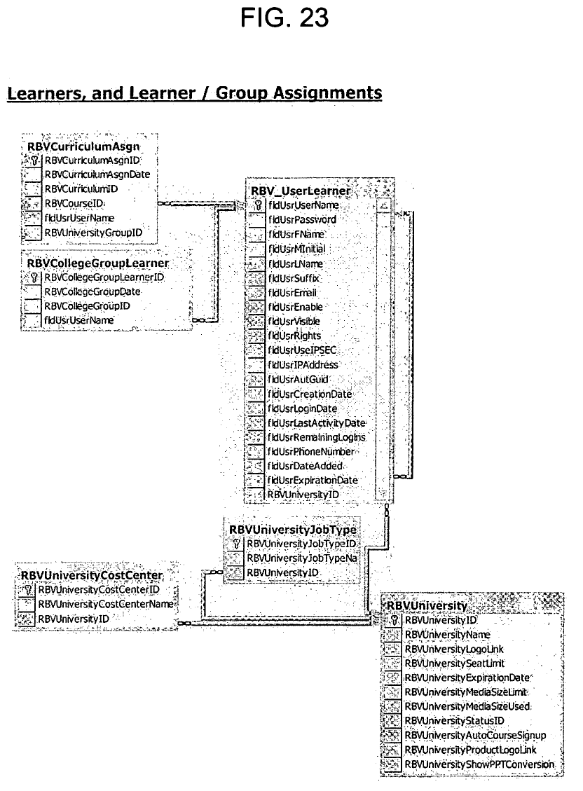

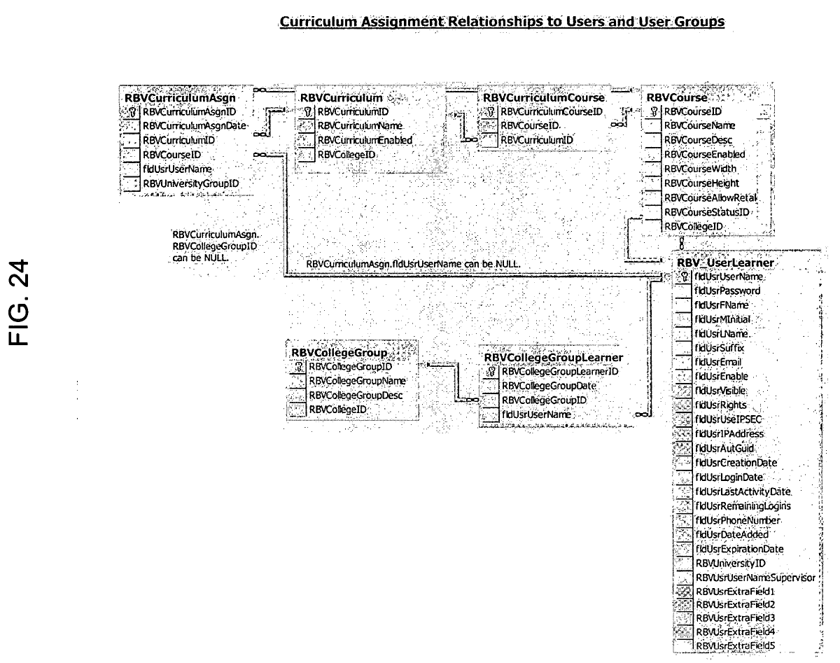

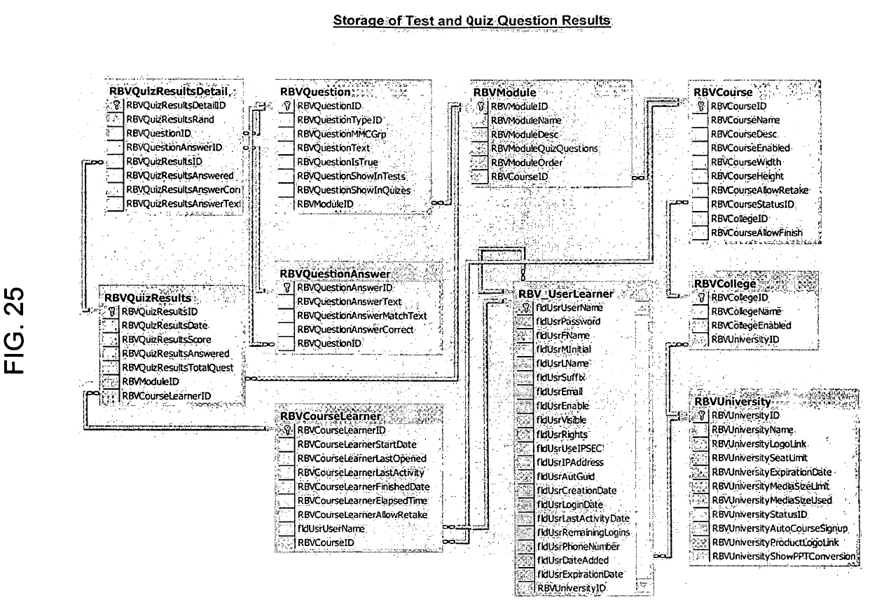

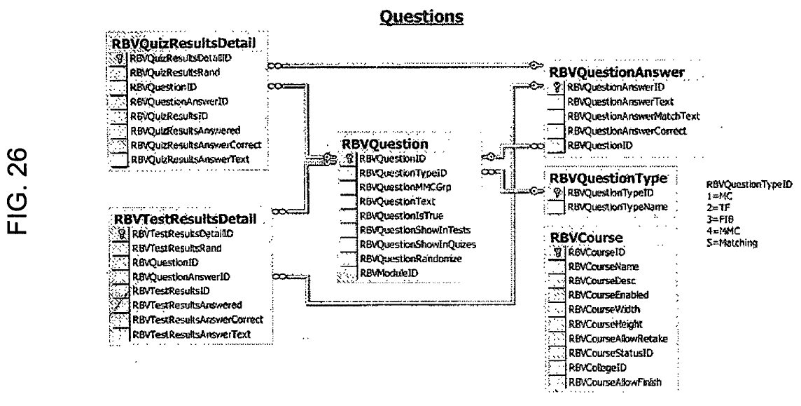

FIG. 22 shows the related database tables associated with the course drilldown design in the preferred embodiment of the present invention. It displays the data stored by database 6 regarding the university, college, curriculum, course, module and page. FIG. 23 depicts the related database tables associated with the learners and assignment of learners to groups in the preferred embodiment of the present invention. It shows the data stored by database 6 regarding curriculum assignments, user learner, university cost center, university job type, and characteristics of the university. FIG. 24 shows the related database tables associated with curriculum assignments to learners and groups. The data stored by database 6 includes: the curriculum assignment, curriculum, curriculum course, course, college group, college group learner, and learner. FIG. 25 shows the related database tables associated with test and quiz results in the preferred embodiment of the present invention. The data stored by database 6 includes: questions, answers, question types, course, quiz results and test results. Finally, FIG. 26 shows the related database tables associated with questions in the preferred embodiment of the present invention. The data stored by database 6 includes: quiz results, test results, questions, answers, question types, and courses.

While a specific embodiment of the invention has been shown and described, it is to be understood that numerous changes and modifications may be made therein without departing from the scope, spirit, and intent of the invention as set forth in the appended claims.

We claim:

1. A web deployed e-learning knowledge management system for remote learning users and remote management controls comprising:
a login system;
a super-administrator portal;
a manager portal;
a builder portal;
a learner portal; and
a database;
wherein said login system is designed to manage access to said super-administrator portal, said manager portal, said builder portal, and said learner portal;
wherein said super-administrator portal is designed to permit at least one super-administrator to establish and manage at least one university and at least one university administrator for at least one university;
wherein said manager portal is designed to permit at least one university administrator to establish and manage at least one builder and at least one learner for at least one university, at least one assessment to be taken by at least one learner, and at least one question for at least one assessment.
wherein said builder portal is designed to permit at least one builder for at least one university to establish and manage at least one college for at least one university, at least one curriculum for at least one college, at least one course for at least one curriculum, at least one module for at least one course, at least one page for at least one module;
wherein said learner portal is designed to permit at least one learner to view at least one course for at least one curriculum, and also to permit at least one learner to take at least one assessment for at least one course;
wherein said database is designed to receive, transmit, and store data used by said login system, said super-administrator portal, said manager portal, said builder portal, and said learner portal; and
wherein said database is interactively connected to said login system, said super-administrator portal, said manager portal, said builder portal, and said learner portal.

2. The web deployed e-learning knowledge management system of claim 1 wherein said super-administrator portal is further designed to permit at least one super-administrator to view reports related to said super-administrator portal.

3. The web deployed e-learning knowledge management system of claim 1 wherein said manager portal is further designed to permit said university administrator to establish and manage at least one group comprised of at least one learner.

4. The web deployed e-learning knowledge management system of claim 1 wherein said manager portal is further designed to permit said university administrator to assign at least one course to at least one learner.

5. The web deployed e-learning knowledge management system of claim 1 wherein said manager portal is further designed to permit said university administrator to assign at least one curriculum to at least one learner.

6. The web deployed e-learning knowledge management system of claim 3 wherein said manager portal is further designed to permit said university administrator to assign at least one course to at least one group.

7. The web deployed e-learning knowledge management system of claim 3 wherein said manager portal is further designed to permit said university administrator to assign at least one curriculum to at least one group.

8. The web deployed e-learning knowledge management system of claim 1 wherein said manager portal is further designed to permit said university administrator to establish and manage at least one question for at least one assessment.

9. The web deployed e-learning knowledge management system of claim 1 wherein said builder portal is further designed to permit at least one builder to automatically convert a Microsoft PowerPoint presentation into at least one module.

10. The web deployed e-learning knowledge management system of claim 1 wherein said builder portal is further designed to permit at least one builder to view reports related to said builder portal.

11. The web deployed e-learning knowledge management system of claim 1 wherein said learner portal is further designed to permit at least one learner to register for at least one course.

12. The web deployed e-learning knowledge management system of claim 1 wherein said learner portal is further designed to permit at least one learner to view a history of assessments completed by at least one learner.

13. The web deployed e-learning knowledge management system of claim 1 wherein said learner portal is further designed to permit at least one learner to view a library of course materials for at least one course.

14. The web deployed e-learning knowledge management system of claim 1 wherein said database is a relational database comprised of a plurality of tables.

15. The web deployed e-learning knowledge management system of claim 1 further comprising:
a means for storing interrelated textual information and graphical information;
generating and displaying a menu bar comprising a plurality of command options;
selecting a command option provided by said menu bar comprising a plurality of command options;
transmitting said command option to generate a report;
compiling said report as said university administrator selects;
generating and displaying said report determined by selection of said command option from said menu; and
storing said report on said system for review and compilation,
wherein generating said report is displayed at a relevant time selected by a user.

16. The web deployed e-learning knowledge management system for remote learning users and remote management controls of claim 1 wherein the user is able to receive, transmit and generate reports to remote access points.

17. A web deployed e-learning knowledge management system for remote learning users and remote management controls comprising:
a login system;
a super-administrator portal;
a manager portal;
a builder portal;
a learner portal; and
a database;
wherein said login portal further comprises a means for managing access to said super-administrator portal, said manager portal, said builder portal, and said learner portal;
wherein said super-administrator portal further comprises a means for permitting at least one super-administrator to establish and manage at least one university and at least one university administrator for at least one university;
wherein said manager portal further comprises a means for permitting at least one university administrator to establish and manage at least one builder and at least one learner for at least one university, at least one assessment to be taken by at least one learner, and at least one question for at least one assessment.
wherein said builder portal further comprises a means for permitting at least one builder for at least one university to establish and manage at least one college for at least one university, at least one curriculum for at least one college, at least one course for at least one curriculum, at least one module for at least one course, at least one page for at least one module;
wherein said learner portal further comprises a means for permitting at least one learner to view at least one course for at least one curriculum, and also a means for permitting at least one learner to take at least one assessment for at least one course;
wherein said database further comprises a means for receiving, transmitting, and storing data used by said login system, said super-administrator portal, said manager portal, said builder portal, and said learner portal; and
wherein said database comprises a means for interactively connecting to said login system, said super-administrator portal, said manager portal, said builder portal, and said learner portal.

18. The web deployed e-learning knowledge management system of claim 17 wherein said super-administrator portal further comprises a means for permitting at least one super-administrator to view reports related to said super-administrator portal.

19. The web deployed e-learning knowledge management system of claim 17 wherein said manager portal further comprises a means for permitting said university administrator to establish and manage at least one group comprised of at least one learner.

20. The web deployed e-learning knowledge management system of claim 17 wherein said manager portal further comprises a means for permitting said university administrator to assign at least one course to at least one learner.

21. The web deployed e-learning knowledge management system of claim 17 wherein said manager portal further comprises a means for permitting said university administrator to assign at least one curriculum to at least one learner.

22. The web deployed e-learning knowledge management system of claim 19 wherein said manager portal further comprises a means for permitting said university administrator to assign at least one course to at least one group.

23. The web deployed e-learning knowledge management system of claim 19 wherein said manager portal further comprises a means for permitting said university administrator to assign at least one curriculum to at least one group.

24. The web deployed e-learning knowledge management system of claim 17 wherein said manager portal further comprises a means for permitting said university administrator to establish and manage at least one question for at least one assessment.

25. The web deployed e-learning knowledge management system of claim 17 wherein said builder portal further comprises a means for permitting at least one builder to automatically convert a Microsoft PowerPoint presentation into at least one module.

26. The web deployed e-learning knowledge management system of claim 17 wherein said builder portal further comprises a means for permitting at least one builder to view reports related to said builder portal.

27. The web deployed e-learning knowledge management system of claim 17 wherein said learner portal further comprises a means for permitting at least one learner to register for at least one course.

28. The web deployed e-learning knowledge management system of claim 17 wherein said learner portal further comprises a means for permitting at least one learner to view a history of assessments completed by at least one learner.

29. The web deployed e-learning knowledge management system of claim 17 wherein said learner portal further comprises a means for permitting at least one learner to view a library of course materials for at least one course.

30. The web deployed e-learning knowledge management system of claim 17 further comprising:
a means for storing interrelated textual information and graphical information;
generating and displaying a menu bar comprising a plurality of command options;
selecting a command option provided by said menu bar comprising a plurality of command options;
transmitting said command option to generate a report;
compiling said report as said university administrator selects;
generating and displaying said report determined by selection of said command option from said menu; and
storing said report on said system for review and compilation,
wherein generating said report is displayed at a relevant time selected by a user.

31. The web deployed e-learning knowledge management system for remote learning users and remote management controls of claim 17 wherein the user is able to receive, transmit and generate reports to remote access points.

32. A method of automatically converting a Microsoft PowerPoint file into SCORM-compliant module for use in a learning management system, said method comprising the steps of:
obtaining an original PowerPoint file;
converting said PowerPoint file to HTML format;
deleting said original PowerPoint file;
modifying a title of said HTML file;
adding SCORM framework files to said HTML file;
obtaining an original PowerPoint course title out of said HTML file;
obtaining a list of HTML-converted files;
creating a new imsmanifest.xml file based on said original PowerPoint course title and said list of HTML-converted files;
creating a new defaults.htm file; and
supplementing the scripts.js file.

33. A method of automatically converting a Microsoft PowerPoint file into SCORM-compliant module for use in a web deployed e-learning knowledge management system for remote learning users and remote management controls, said method comprising the steps of:
obtaining an original PowerPoint file;
converting said PowerPoint file to HTML format;
deleting said original PowerPoint file;
modifying a title of said HTML file;
adding SCORM framework files to said HTML file;
obtaining an original PowerPoint course title out of said HTML file;
obtaining a list of HTML-converted files;
creating a new imsmanifest.xml file based on said original PowerPoint course title and said list of HTML-converted files;
creating a new defaults.htm file; and
supplementing the scripts.js file.
